(19) United States
(12) Patent Application Publication
(10) Pub. No.: US 2004/0010733 A1
(43) Pub. Date: Jan. 15, 2004

(54) System and method for fault identification in an electronic system based on context-based alarm analysis

(76) Inventors: Veena S., Bangalore (IN); G. Sridhar, Bangalore (IN); V. Sridhar, Bangalore (IN); K. Kalyana Rao, Bangalore (IN)

Correspondence Address: Venable, P.O. Box 34385, Washington, DC, 20043-9998, US

(21) Appl. No.: 10/191,077

(22) Filed: Jul. 10, 2002

(51) Int. Cl. H04L 1/22

(52) U.S. Cl. 714/27

(57) ABSTRACT

A fault identification system consisting of multiple reasoning engines and the blackboard analyzes alarm information and the associated contextual information to identify faults. The contextual information associated with an alarm is derived by analyzing the alarm along four spaces, namely, transaction-space, function-space, execution-space, and signal-space. The reasoning engines associated with these spaces infer and/or validate the occurrences of faults. Transaction reasoning engine, using the associated knowledge repository, processes the generated alarms to infer and validate faults. Monitor reasoning engine, using the associated knowledge repository, processes domain specific monitor variables to infer faults. Execution reasoning engine, using the associated knowledge repository, processes execution specific monitor variables to infer and validate faults. Function reasoning engine, using the associated knowledge repository, reasons to infer and validate faults. Signal reasoning engine, using the associated knowledge repository, processes hardware specific and environment variables to infer and validate faults. Global reasoning engine moderates the inferences and validations by other reasoning engines to provide consolidated fault inference. The invention also provides a process, “design for diagnosis,” for designing electronic systems with maximum emphasis on fault diagnosis.

### FIELD OF INVENTION

The present invention relates to the field of fault identification in an electronic system and more particularly, to identify the occurrence of a fault in a complex electronic system based on alarm processing. Still more particularly, the invention relates to systems and methods for efficient alarm analysis and fault identification based on design for diagnosis.

### BACKGROUND OF THE INVENTION

Fault isolation in electronic devices such as network elements and communication switches is a challenging task due to enormity of alarm data, ambiguous alarm information (false or missing alarms, redundant alarms, out of sequence alarms etc.) and insufficient alarm-based information for some faults. Hence, there is a need for a mechanism for fast and efficient processing of a large number of alarms.

Existing solutions for fault isolation are mainly of the following categories based on the approach employed for fault diagnosis and isolation:

Rule Based Event Correlation

Rule based systems are based on expert knowledge to identify set of rules to correlate alarms to faults. In case of large network systems, these rules can be very complex and large in number resulting in difficulties in the management of these rules and leading to inaccurate inference of faults. These systems are sensitive to missing and false alarms and out of sequence alarms.

Model Based Reasoning

In model based systems, fault isolation is based on the models of the systems. The alarms are processed with the help of these models to isolate the faults. However, it is difficult to model complex systems to achieve accurate fault isolation.

Case Based Reasoning

Case based reasoning is based on the history of solved problems. A strategy to solve the problem is based on the case history. These systems require exhaustive case database consisting of solution strategy for each case. Huge case database result in high search time and hence affecting the time required for fault isolation.

Probability Network/Bayesian Network

Fault isolation based on Bayesian network is used in conjunction with other fault isolation mechanisms. Probability networks may be advantageous if they can produce hypotheses with a precise confidence level.

### DESCRIPTION OF RELATED ART

Diagnosing an electronic system is a challenging task despite the availability of enormous alarm information. The ambiguity and redundancy associated with alarm information presents a challenge for fast and accurate fault identification.

For majority of the existing systems, the focus has been on performance and throughput aspects, rather than fault diagnosis. Focusing the design towards efficient fault diagnosis enhances precision and speed of diagnosis.

U.S. Pat. No. 6,356,885 to Ross; Niall, White, Anthony Richard for “Network Model For Alarm Correlation” (issued Mar. 12, 2002 and assigned to Nortel Networks Limited (St. Laurent, Calif.)) describes a method of processing alarms in a network adapting virtual model wherein each network entity offers and receives services to and from other entities and having associated knowledge based reasoning capacity, such as rules, for adapting the model. Cause of an alarm is determined using the virtual model.

U.S. Pat. No. 6,076,083 to Baker; Michelle for “Diagnostic system utilizing a Bayesian network model having link weights updated experimentally” (issued Jun. 13, 2000) describes a system utilizing a Bayesian network model with an algorithm quantifying the strength of the links and a method to automatically update probability matrices of the network on the basis of collected experiential knowledge. Probability networks are ineffective if they cannot produce hypotheses with a precise confidence level.

U.S. Pat. No. 4,812,819 to Corsberg; Daniel R for “Functional relationship-based alarm processing system” (issued Mar. 14, 1989 and assigned The United States of America as represented by the United States (Washington, D.C.)) describes a system and method that analyzes each alarm as it is activated and determines its relative importance with other currently activated alarms in accordance with the functional relationships that the newly activated alarm has with other currently activated alarms. Four hierarchical relationships are defined by this alarm filtering methodology: (1) there are two alarm settings on the same parameter; (2) causal factors between two alarms; (3) system response within a specified time following activation of an alarm; and (4) unimportant alarms that are normally expected. This invention addresses alarm processing in terms of reducing the complexity and enormity of the alarm information; however it does not address the issues such as ambiguity and insufficiency of alarm related information.

U.S. Pat. No. 6,249,755 to Yemini; Yechiam; Yemini; Shaula; Kliger; Shmuel for “Apparatus and method for event correlation and problem reporting” (issued Jun. 19, 2001 and assigned to System Management Arts, Inc. (White Plains, N.Y.)) describes:

1. Event and propagation model—Model consisting of exceptional events, local symptoms, potential relationships for event propagation;

2. Creating causality matrix of problems and symptoms—Mapping of symptoms to likely problems with associated probabilities;

3. Finding optimal code book—Based on a minimal subset of symptoms that provide an acceptable level of problem identification; and

4. Fault Isolation using optimal code book—Continuos monitoring and decoding of the symptoms by locating best fit problem in the optimal code book which matches a particular set of symptoms.

This invention makes implicit assumptions such as every fault has a unique set of alarms and the information accompanying alarms are sufficient to identify a fault.

Use of blackboard architecture in case based diagnostics and diagnosing nuclear power plants was proposed in some of the prior art (Rissland, E., Daniels, J., Rubinstein, B., and Skalak, D., “Case-Based Diagnostic Analysis in a Blackboard Architecture”, in the Proceedings of the Eleventh National Conference on Artificial Intelligence, pp 66-72, Washington, 1993.)

The detection of faults, based on monitoring of behavior of the variables, involves generation of variable level alarms based on the magnitude of the detected changes as compared to the normal situation was discussed in the literature (Marina Thottan and Chuanyi Ji, “Adaptive thresholding for proactive network problem detection,” Proceedings IEEE Internation Workshop on Systems Management, pp. 108-116, Newport, R.I., April 1998).

Another prior art refers to the model-based monitoring and diagnosis system based on Qualitative Reasoning where hierarchical models are used to monitor and diagnose dynamic systems (Franz Lackinger and Wolfgang Nejdl, “Diamon: a model-based troubleshooter based on qualitative reasoning” in IEEE Expert 8(1): 33-40, February 1993).

### SUMMARY OF THE INVENTION

The present invention provides a method and apparatus for efficiently identifying the faults occurring in an electronic system based on the analysis of observed alarm information. More specifically, the present invention provides methods for reducing the ambiguity and complexity arising due to the enormity of the alarms generated by the system.

One aspect of the invention is to provide for the definition of additional contextual information associated with the alarms by observing the electronic system along the four dimensions namely, Transaction-space, Function-space, Execution-space and Signal-space. Each of these spaces provide additional contextual information for the alarms generated and thus enhancing the semantic content of the alarms.

Another aspect of the invention is to provide for identification and analysis of alarm-independent system variables (monitor variables), which provide additional contextual information on the functional, performance, and environmental aspects of the electronic system. Analysis of data obtained from the monitor variables is used to resolve the ambiguity resulting out of missing and false alarms.

Yet another aspect of the invention is an apparatus for collecting and processing of contextual information along with alarm information to identify a fault. This apparatus consists of a blackboard and multiple reasoning engines for processing each of the kind of contextual information, namely, Transaction reasoning engine (TRE), Function reasoning engine (FRE), Signal reasoning engine (SRE), Execution reasoning engine (ERE), Monitor reasoning engine (MRE) and Global reasoning engine (GRE).

Another aspect of the invention is a method for processing of alarms, in which alarms are processed collaboratively by the various reasoning engines.

Yet another aspect of the invention is a definition of a process for the design of the system based on the “Design for Diagnosis” approach. DFD approach is an enhanced hardware-software co-design methodology to improve the diagnosibility of the system. This methodology provides a process to collect the knowledge and database information during the system design and to identify contextual information and design of means for collecting the contextual information from CES at run-time.

Present invention is advantageous in reducing the complexity of alarm processing arising out of enormity of alarms by logically grouping them based on transactions.

Present invention further addresses the problem of ambiguity in alarm information by providing a method for using monitor variables for ambiguity resolution and addresses the problem of insufficiency of information accompanying the alarms, by defining additional contextual information and providing methods for collecting and analyzing the contextual information.

### BRIEF DESCRIPTION OF DRAWINGS

FIG. 1A illustrates the blackboard architecture of Fault Identification System (FIS)

FIG. 1B illustrates various spaces and space mapping

FIG. 1C illustrates resource hierarchy

FIG. 1D illustrates inter-relation between usecase, transaction, alarm map and annotation

FIG. 1E illustrates context association with the alarm

FIG. 2A illustrates the architecture of Transaction Reasoning Engine (TRE)

FIG. 2A-1 illustrates typical data representation of transaction information

FIG. 2B illustrates processing of usecase begin notification by TRE

FIG. 2C illustrates processing of transaction begin notification by TRE

FIG. 2D illustrates processing of alarm notification by TRE

FIG. 2D-1 illustrates processing of DSs by TRE

FIG. 2E illustrates processing of AMV change notification by TRE

FIG. 2F illustrates processing of transaction end notification by TRE

FIG. 2G illustrates processing of usecase end notification by TRE

FIG. 2H illustrates processing of fault validation request by TRE

FIG. 2I illustrates processing of fault rectified and fault rejected notifications by TRE

FIG. 3A illustrates the architecture of Monitor Reasoning Engine (MRE)

FIG. 3A-1 illustrates typical data representation of monitor information

FIG. 3B illustrates processing of DMV change notification by MRE

FIG. 3B-1 illustrates processing of timer notification by MRE

FIG. 4A illustrates the architecture of Execution Reasoning Engine (ERE)

FIG. 4A-1 illustrates typical data representation of execution information

FIG. 4B illustrates processing of EMV change notification by ERE

FIG. 4B-1 illustrates processing of timer notification by ERE

FIG. 4C illustrates processing of fault validation request by ERE

FIG. 4D illustrating processing of fault rectified by ERE

FIG. 5A illustrates the architecture of Function Reasoning Engine (FRE)

FIG. 5A-1 illustrates typical data representation of function information

FIG. 5B illustrates processing of MF_MV notification by FRE

FIG. 5C illustrates processing of fault validation request by FRE

FIG. 5D illustrates processing of fault rectification by FRE

FIG. 6A illustrates the architecture of Signal Reasoning Engine (SRE)

FIG. 6A-1 illustrates typical data representation of signal information

FIG. 6B illustrates processing of HMV/EMV change notification by SRE

FIG. 6B-1 illustrates processing of timer notification by SRE

FIG. 6C illustrates processing of fault validation request by SRE

FIG. 7A illustrates the architecture of Global Reasoning Engine (GRE)

FIG. 7A-1 illustrates typical data representation of global information

FIG. 7B illustrates computation of final fault probability by GRE

FIG. 7C illustrates processing of fault rectified and fault rejected notifications by GRE

FIG. 8 illustrates the hardware architecture of FIS system

FIG. 9A illustrates the overview of Design For Diagnosis (DFD) process

FIG. 9B illustrates DFD process I

FIG. 9C illustrates DFD process II

### DETAILED DESCRIPTION OF THE PREFERRED EMBODIMENT

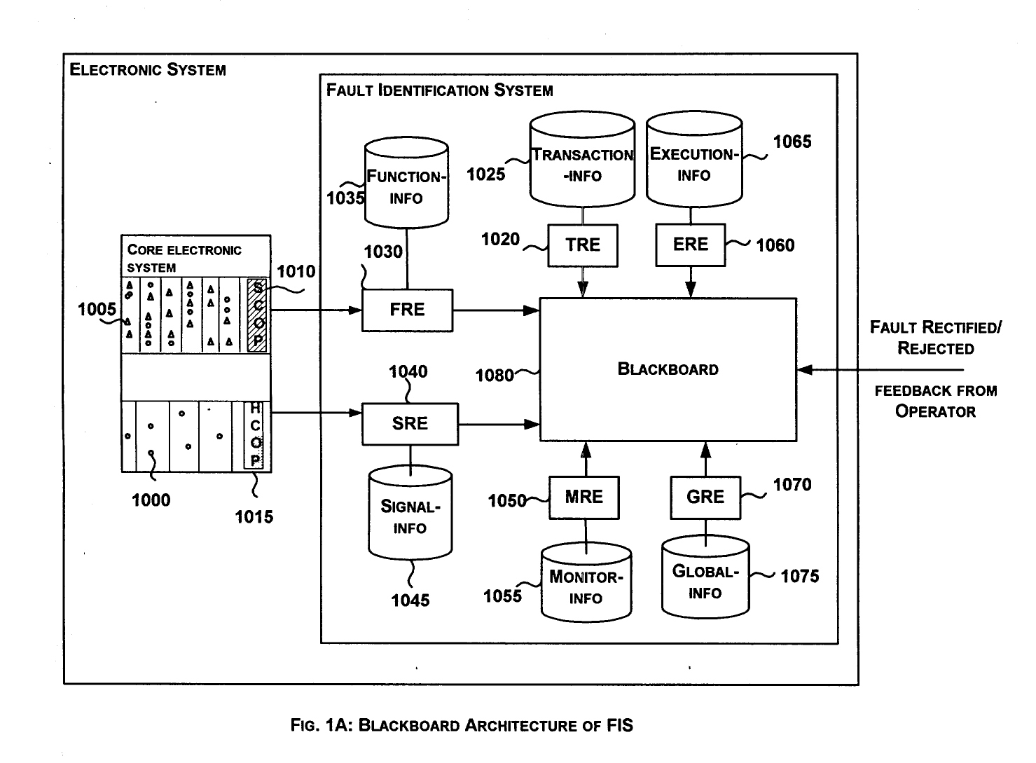

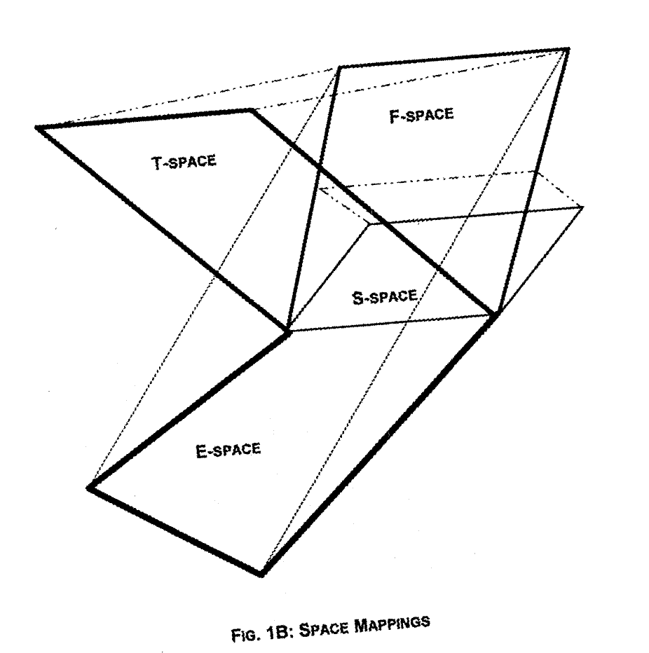

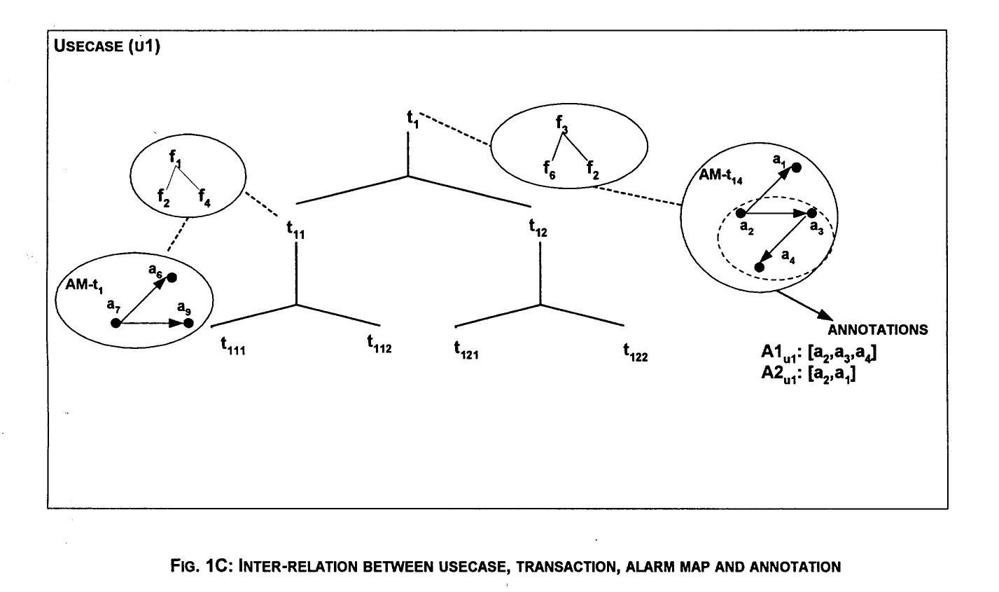

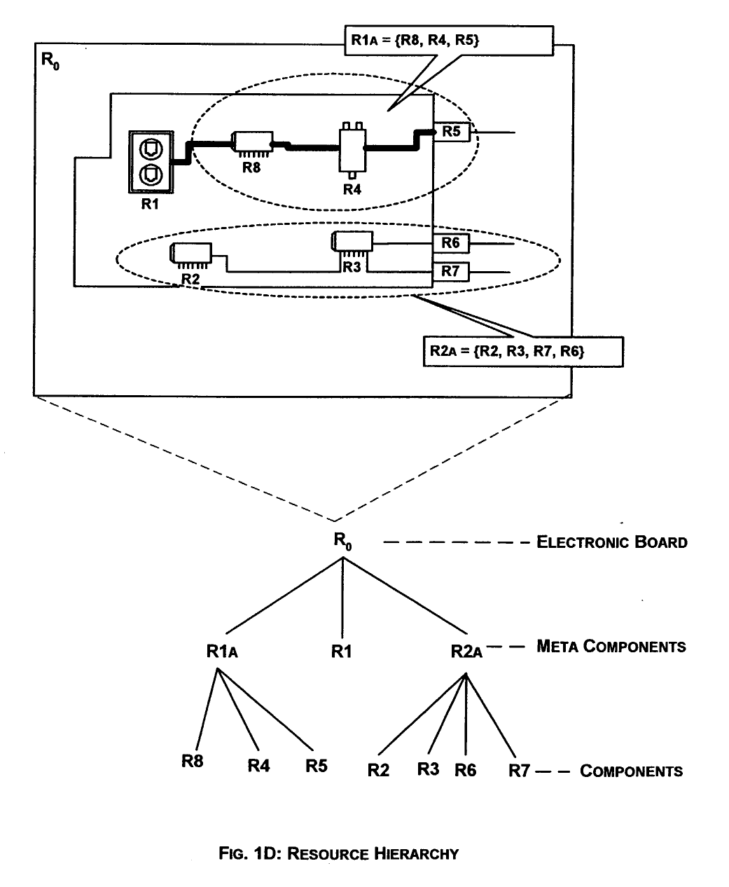

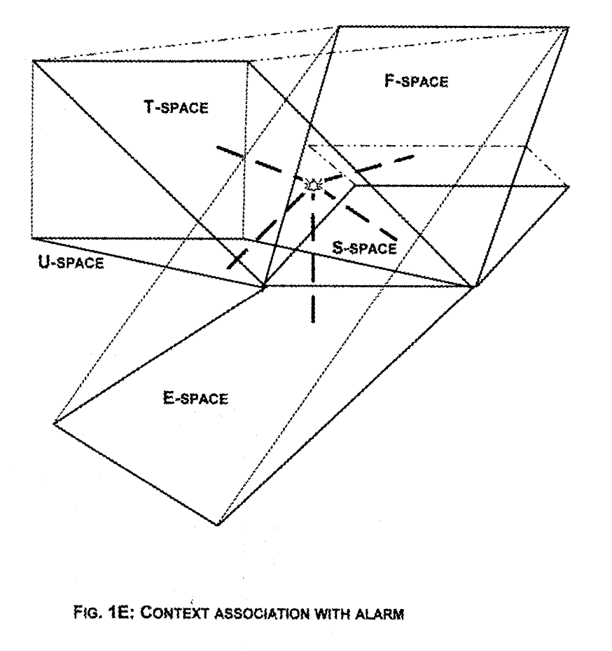

FIG. 1A illustrates a blackboard based architecture of Fault Identification System (FIS). In a preferred embodiment, FIS is part of an Electronic System (ES) and identifies faults in Core Electronic System (CES). Primary objective of FIS is to process alarms to identify faults. The approach for alarm processing is based on the generation and analysis of contextual information using multiple knowledge repositories. Each KR is maintained by an RE over the lifecycle of the core electronic system and the RE processes the knowledge during reasoning to aid in alarm processing. The blackboard architecture facilitates the collaborative identification of faults involving multiple REs.

Nano-Agents (ηAs) (1000) are implemented in the core electronic system to facilitate the collection of contextual information to monitor the state of hardware and software of CES. Function-stones (f-stones) (1005) are implemented in critical functions identified during the design of CES to collect the information related to the transaction and the usecase associated with the function under execution.

A component SCOP (1010) collects the information from software ηAs, filters information based on pre-defined requirements, and communicates this information to FIS.

A component HCOP (1015) collects the information from hardware ηAs (in SoCs and ASICs) and sensors, filters information based on pre-defined requirements, and communicates this information to FIS.

FIS comprises of the following REs:

Transaction Reasoning Engine (TRE) (1020): A sequence of function invocations defines a transaction and each such transaction is associated with an alarm map where the alarm map provides the relationship among the alarms that could get generated while executing the transaction. In order to reduce the non-determinism in alarm processing, the definition of transaction is restricted to a unit that gets executed completely in a thread or process. Conventionally, alarms get associated at the lowest level with functions and at a higher level with, say, usecases. Functions and usecases are the two extremes of the spectrum of possibilities. In former case, the association is at too low a level (and hence, it is required to process with limited context) while in latter case, the association is at a higher level (and hence, it is required to process with general context). Definition of a transaction as something that is in between the above two extreme cases helps to reduce the complexity with adequate context information. TRE processes alarms on per transaction basis to determine a sequence of alarms (alarm annotations) directly or indirectly leading to the identification of faults. Transaction-wise alarm processing is aimed at reducing the ambiguity in alarm processing due to the concurrency in CES. Furthermore, the concurrent processing of alarms results in relatively faster processing of generated alarms. Transaction-Info is the knowledge repository of TRE (1025).

Function Reasoning Engine (FRE) (1030): At the lowest level, alarms are generated by the functions and these functions define the context in which alarms are generated. Collection and analysis of this contextual information along with the alarms aid in semantic correlation of alarms. FRE collects the contextual information from ηAs and f-stones through SCOP. FRE analyses an alarm from function perspective to correlate alarms with functions, which is used to validate faults. Function-Info is the knowledge repository of FRE (1035).

Signal Reasoning Engine (SRE) (1040): Hardware is the heart of the CES and state of the hardware needs to be monitored to correlate alarms with hardware faults. Hardware components have a finite lifetime and are sensitive to the environment in which they operate. SRE analyses the information related to the operating environment, age of the hardware component, and additional contextual information to identify and validate the hardware faults. Signal-Info comprising of hardware-specific signatures, hardware-specific MV data and hardware-specific rules is the knowledge repository of SRE (1045).

Monitor Reasoning Engine (MRE) (1050): Most often alarm information alone is inadequate to identify all the faults. Hence, there is a need to periodically collect and analyze the domain-specific information to identify faults. The domain-specific information consists of software monitor variables to infer faults. Domain-specific signatures database, domain-specific MV data and domain-specific rules are part of Monitor-Info, the knowledge repository of MRE (1055).

Execution Reasoning Engine (ERE) (1060): Most of the electronic systems are concurrent systems wherein multiple tasks are carried out simultaneously. Concurrency in CES leads to ambiguities while processing alarms. Hence, there is a need to monitor system-specific monitor variables that monitor each of the execution units (such as threads or processes) independently to infer faults. Execution-Info comprising of execution-specific MV data, execution-specific signatures and execution-specific rules is KR of ERE (1065).

Global Reasoning Engine (GRE) (1070): Each of the REs described above has an ability to infer and/or validate an occurrence of a fault. Inference or validation of a fault by a reasoning engine is considered as a vote for or against the occurrence of the fault by the reasoning engine. GRE computes the probability of occurrence of a fault based on the majority of votes on fault inference and validation by various REs. Global-Info is the knowledge repository of GRE (1075). Knowledge part of the repository refers to learning of correction factors, which are applied to the fault inferences posted by various REs. Based on positive and negative examples, GRE learns these correction factors for each individual RE.

The blackboard in FIS is a shared memory through which various subsystems share the data among themselves using a messaging mechanism (1080).

Upon receiving a fault identification notification from GRE, FIS notifies about the fault occurrence to the operator. Subsequent feedback from the operator is collected by FIS either as fault rectified or rejected and posted to the blackboard.

Modularity in collaborative reasoning with multiple REs localizes the updation required due to continuos changes in evolving systems. For example, if hardware of CES is enhanced, enhancement is updated mostly in SRE, without disturbing other REs.

FIG. 1B illustrates the representation of CES, visualized in terms of multiple logical (semantic) and physical (hardware/software) spaces to define contextual information for alarms.

The spaces are:

| | |
|---|---|
| Function space (F-space) | - physical and soft space |
| Resource space and Signal space (S-space) | - physical and hard space |
| Execution space (E-space) | - physical and soft space |
| Transaction space (T-space) | - logical space |

F-space is a set of software function hierarchies where each hierarchy comprises of multiple functions based on caller-callee relationship. Every function conceptually belongs to one or more transactions.

Resource and signal spaces together cover the complete hardware of CES. Resource space defines the hardware resources such as ASIC, SoC, microprocessors, memory modules, and discrete components of CES. Signal space defines signal flow in the hardware. Elements of a signal space are two or more resource space elements that are connected by signal paths. Signal and resource spaces are together referred as S-space.

Another soft space that provides additional contextual information is E-space. E-space is a set of execution units (Eᵢ). In every execution unit, a set of transactions get executed.

A transaction space enables a logical grouping and processing of alarms with additional contextual information. A sequence of function invocations defines a transaction and the definition of a transaction is restricted to a unit that gets executed completely in a thread or process. Transactions that directly interact with the hardware components (one or more signal space elements) are referred as Kernel Transaction (KT). T-space is a set of transaction hierarchies where each hierarchy (Tᵢ) comprises of multiple transactions (tⱼ's). Several tⱼ's in a hierarchy could be related to each other in many ways. A few examples of relations among tⱼ's in a Tᵢ hierarchy are: Mutually Exclusive (execution of one transaction rules out the execution the other transaction), Conditional (a transaction is executed on a condition), sequential (two transactions are executed one after another), concurrent (two transactions are executed simultaneously), and transactions with common inputs/shared data (two transactions operate on a shared resource).

FIG. 1C illustrates the inter-relation among usecases, transactions, functions and alarms. A set of functions are associated with a transaction and a set of transactions are associated with a usecase. However, there could be some functions in the system which are not associated with any of the identified usecases. Such functions are grouped under one or more system usecases. The set of functions associated with all the usecases, including system usecases, account for the all the functions defined as part of the CES software. Each transaction hierarchy corresponds to a usecase of CES and each individual transaction is associated with an alarm map where the alarm map provides the relationship among the alarms that could get generated while executing the transaction. A sequence of alarms in a transaction directly or indirectly leading to the identification of faults is defined as an alarm annotation.

FIG. 1D illustrates a typical resource hierarchy showing resource grouping at different levels such as board level, meta-component level and component level.

FIG. 1E illustrates the contextual information that is associated with an alarm:

Timestamp at which alarm is generated

Usecase associated with the generating function

Transaction associated with the generating function

Function generating the alarm

Execution thread of the generating function

Resources associated with the generating function, transaction, or usecase.

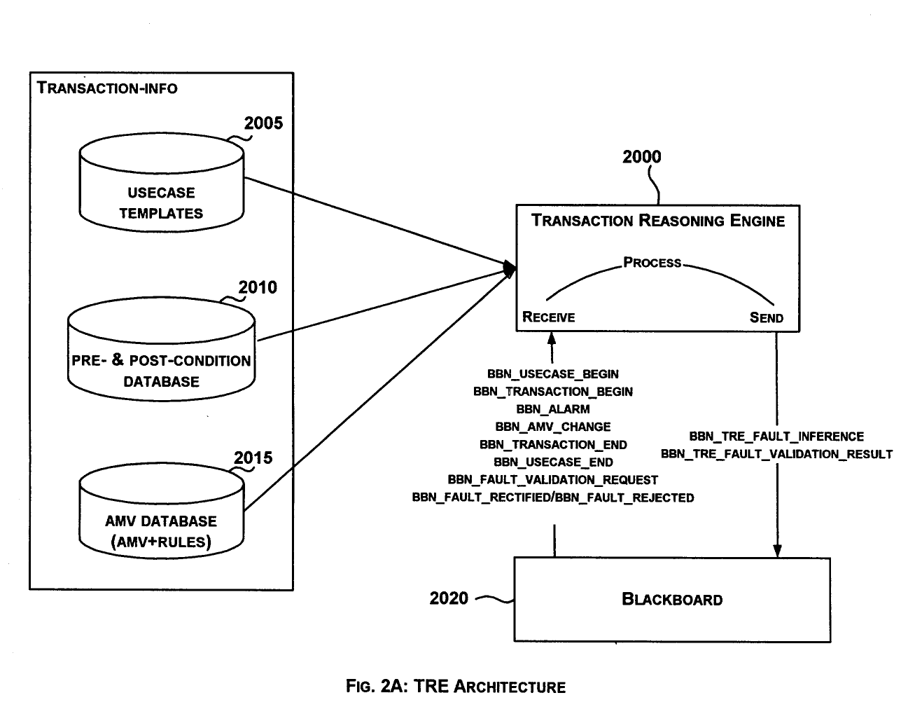

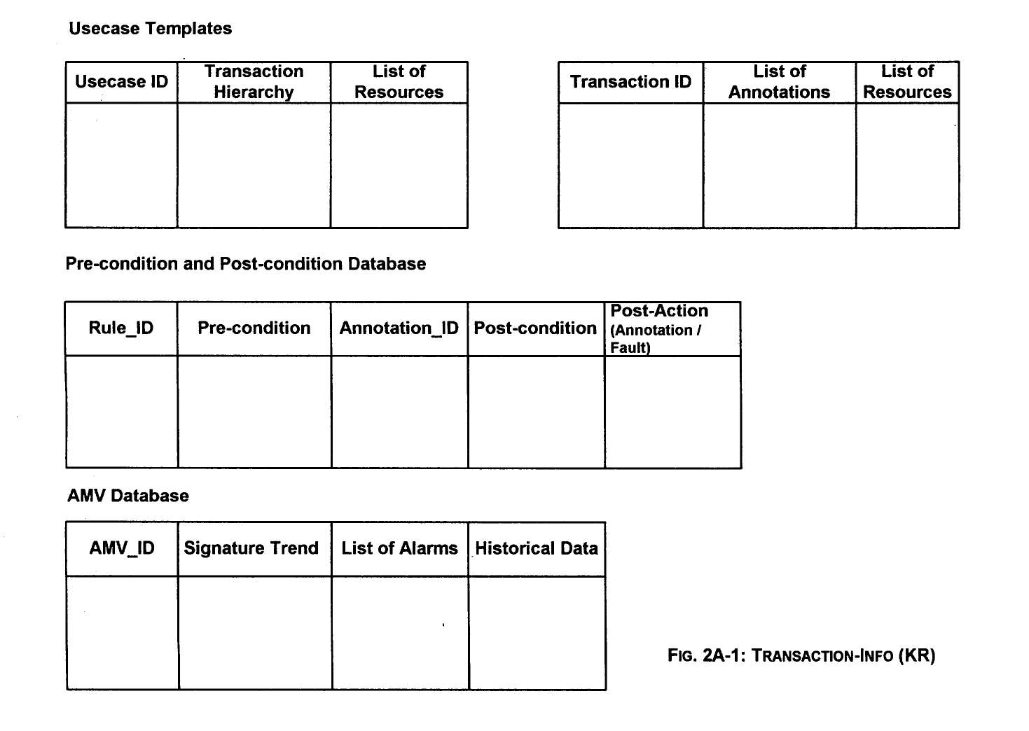

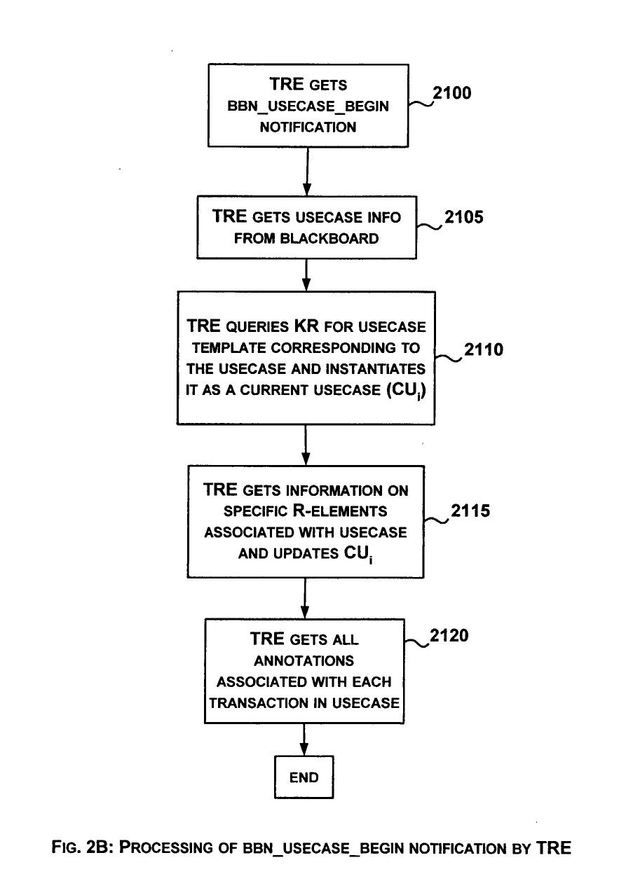

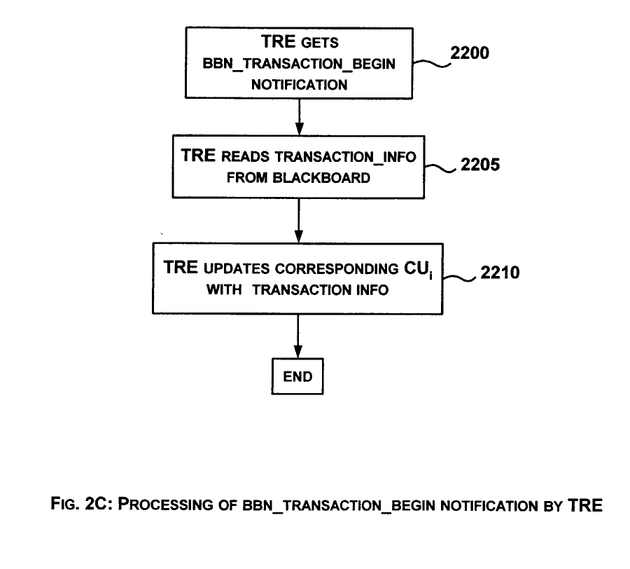

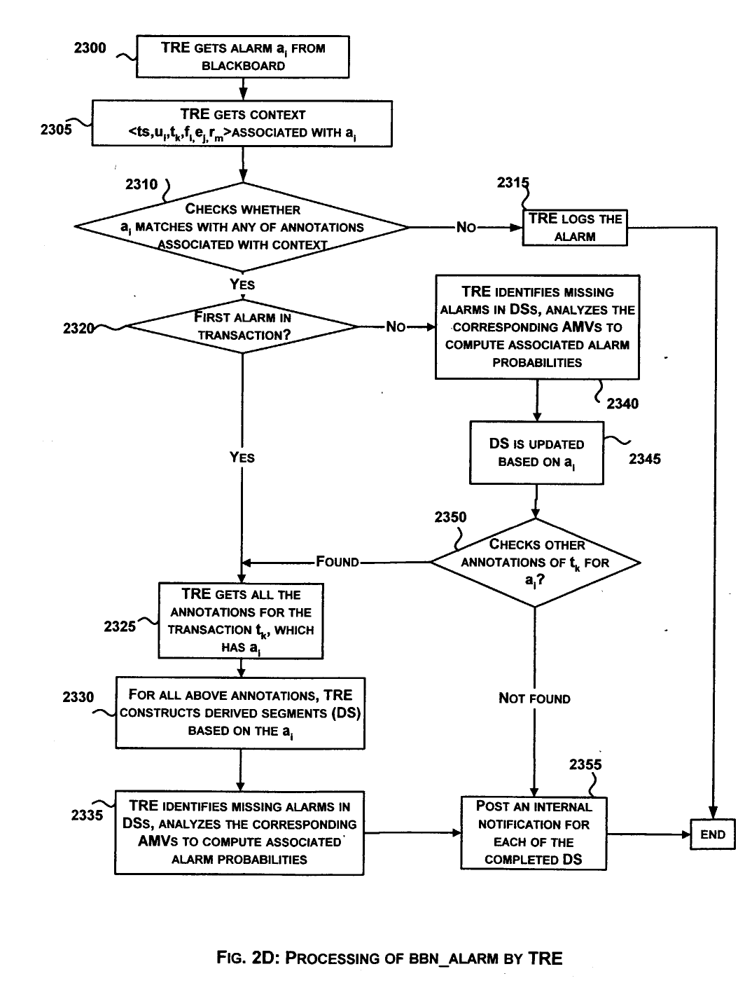

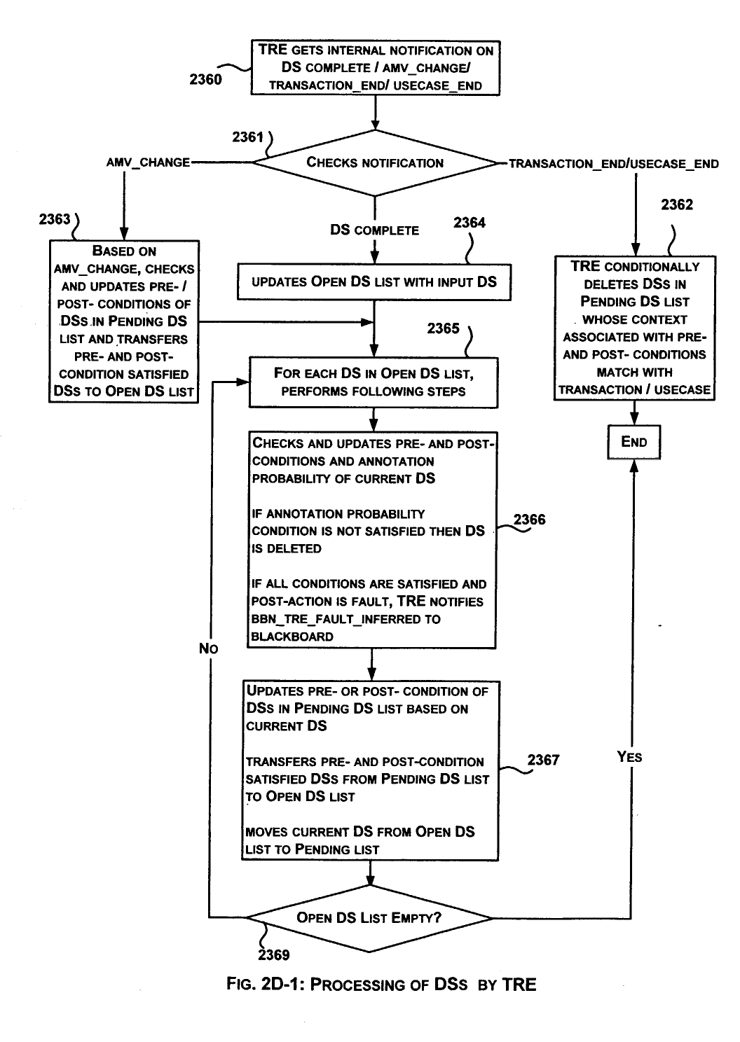

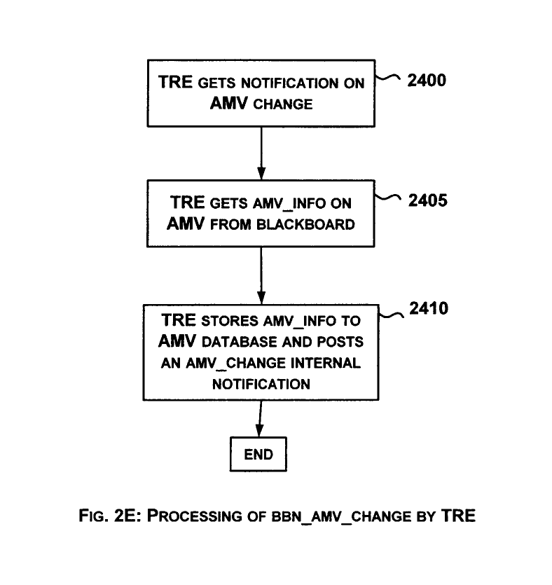

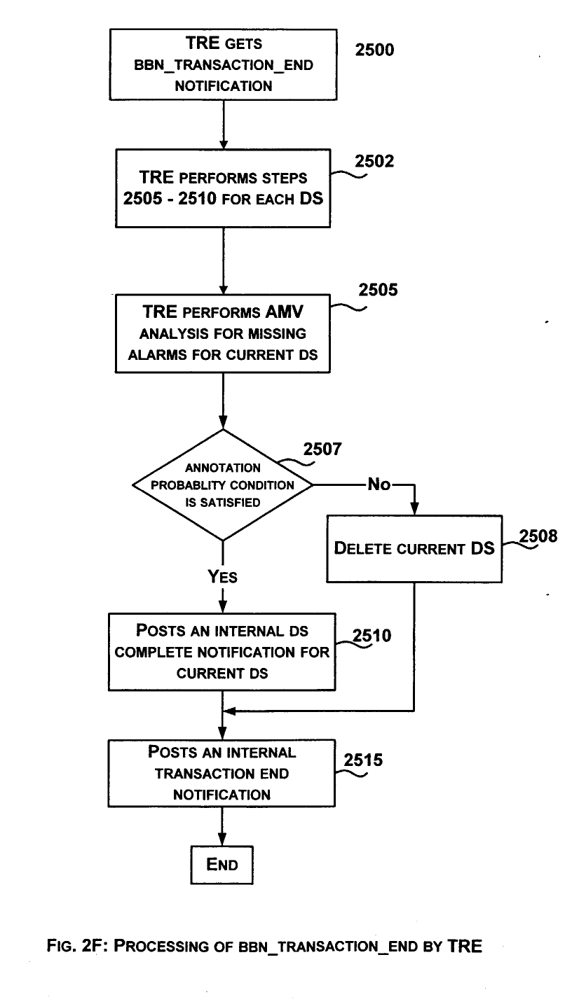

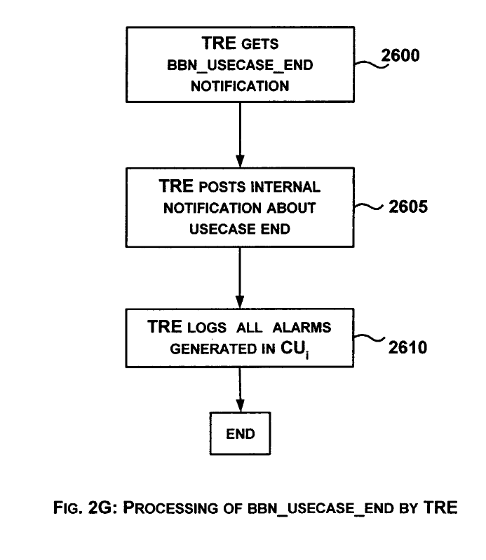

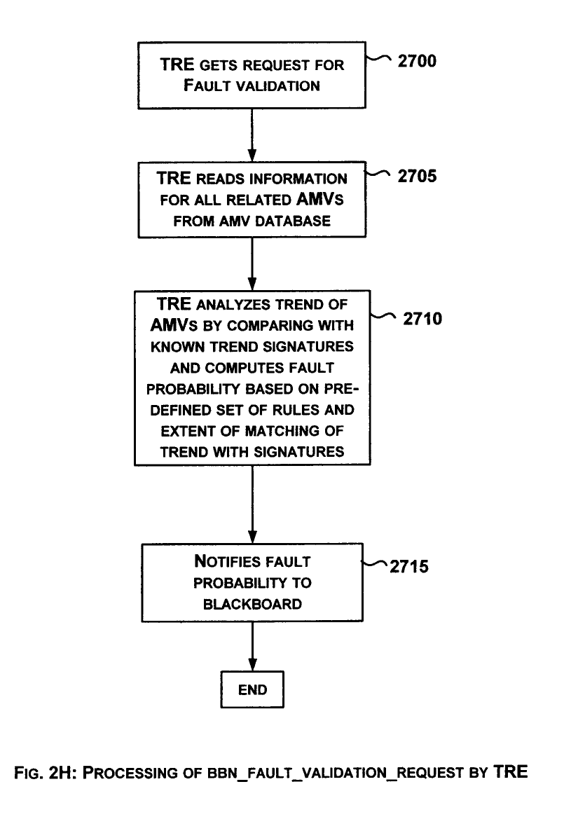

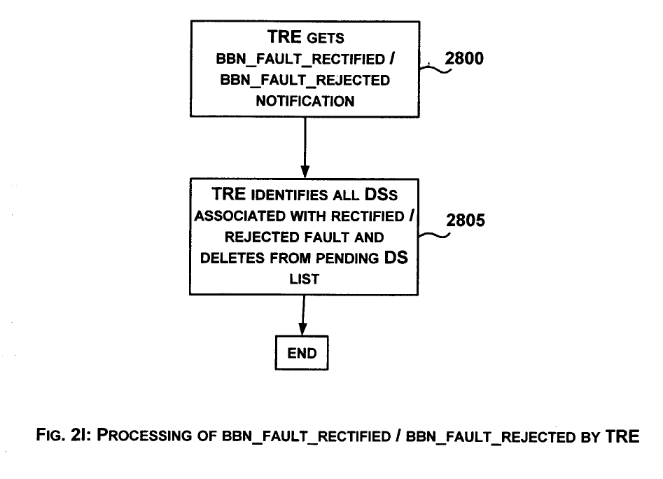

FIG. 2A illustrates the architecture of the Transaction Reasoning Engine (TRE). TRE (2000) receives notifications from the blackboard (2015) regarding current alarm, begin or end of a usecase, begin or end of a transaction, request for validation of occurrence of a fault or a change in alarm specific MV (AMV). TRE uses the information available in knowledge repository consisting of usecase templates (2005), and pre- and post-condition database (2010) to process the notifications received from the blackboard and to identify the faults based on alarms generated in various transactions. A usecase template defines the transaction hierarchy associated with a usecase. Pre- and post-condition information consists of rules to relate annotations to annotations in other transactions or to faults. Typical pre-conditions are AMV support to the annotations and co-occurrence of an annotation, and specific rules in terms of annotation probabilities. Typical post-conditions are rules in terms of specific AMV support and annotation probabilities. Both pre- and post-conditions are context-sensitive. Post-action is the expected result when post conditions are satisfied and this could be an expectation of annotation or inference of a fault. AMV database comprises of rules to analyze AMVs to resolve ambiguities while processing alarms. Further, TRE validates the fault inferences posted by other reasoning engines based on the AMV analysis (2015). AMVs, associated with a context, are collected by ηAs and are stored in AMV database.

FIG. 2A-1 illustrates typical data representation of transaction information as stored in the KR.

FIG. 2B illustrates the procedure for processing of BBN_USECASE_BEGIN notification by TRE. Usecases are identified during the CES design and f-stones implemented in CES provide usecase execution information. The beginning of a usecase is notified by f-stone to the blackboard through SCOP and FRE. TRE gets the notification of the beginning of a usecase from the blackboard (2100). TRE collects the usecase information related to the notification (2105) consisting of current execution thread information, usecase identifier, and usecase instance identifier. TRE queries KR for the usecase template corresponding to the usecase identifier and instantiates the template as a current usecase (CUᵢ) (2110). TRE gets information on specific R-elements associated with the usecase as part of the usecase information from usecase templates database and updates CUᵢ (2115). For example, in case of “call setup” usecase in a communication switch, one of the R-elements associated with the usecase is the specific physical port. TRE updates CUᵢ with this information. Further, TRE queries KR for all possible annotations corresponding to all the transactions in the usecase and updates CUᵢ with this information (2120).

FIG. 2C illustrates the procedure for the processing of BBN_TRANSACTION_BEGIN notification by TRE. Beginning of a transaction is notified by an f-stone to the blackboard via SCOP and FRE. TRE receives this notification from the blackboard (2200). TRE collects the transaction-related information such as transaction id and usecase id from the blackboard (2205) and updates CUᵢ with this information (2210).

FIG. 2D illustrates the procedure for processing of BBN_ALARM notification by TRE. SCOP collects and notifies the alarms generated during a transaction to the blackboard via FRE. TRE receives the notification and reads the alarm information such as alarm id and the associated contextual information from the blackboard (2300). TRE processes this information and identifies the transaction to which this alarm belongs to (2305). TRE checks whether the current alarm matches with any of the annotations associated with the context (2310). If the alarm is an out of context alarm, TRE logs the alarm (2315) for a later processing.

TRE further checks if this alarm is the first one in the identified transaction (2320). If the alarm generated is the first alarm in the identified transaction, TRE further processes the alarm, by getting all possible annotations containing the alarm for the identified transaction (2325). For all of the above annotations, TRE constructs derived segments (DS) based on the generated alarm (2330). A derived segment (DS) is a part of an annotation consisting of the alarms that have occurred and the alarms, which are missing but have AMV support. For example, if alarms a1 and a3 have occurred in sequence and if corresponding annotation is [a1, a2, a3], then the derived segment is considered as DS=[a1, a2, a3] with a2 as a missing alarm. Support for a missing alarm is derived from the analysis of the associated AMV information. If the AMV information supports the occurrence of the missing alarm, then alarm is considered to have occurred and appropriate probability is associated with the occurrence. For each of the identified annotations, TRE constructs the derived segments and updates these derived segments based on the occurrence of the alarm and the AMV analysis of the missing alarms (2335).

Validation of a missing alarm is based on the processing of the rules related to an appropriate AMV. The probability of occurrence of the missing alarm is estimated based on the extent of matching of the AMV with respect to the rules and it is used to define the probability of the occurrence of the alarm.

As further alarms occur, the derived segments are updated incrementally as described in steps 2340 through 2355.

An example provided below explains the construction of derived segments:

Example 1: Consider the following four sample annotations:

Annotation 1=[a1, a2, a5*] where a5* indicates that zero or more alarms can get generated

Annotation 2=[a1, a6+, a8] where a6+ indicates that 1 or more alarms can get generated

Annotation 3=[a9, a1, a10, a11]

Annotation 4=[a6, a7]

On occurrence of first alarm a1, annotations 1, 2, and 3 contain the alarm a1 and hence these are selected for defining the derived segments.

DS1=[a1] based on comparison with Annotation 1

DS2=[a1] based on comparison with Annotation 2

DS3=[a9, a1] based on comparison with Annotation 3 and although alarm a1 has occurred, a9 is missing. TRE analyses the information related to the associated AMV to validate the support for the missing alarm, and based on the support for the occurrence of the missing alarm, the derived segment is updated.

In case when the alarm received is not the first one in the transaction (2320), TRE checks the generated alarm with respect to each of the DSs (2340). Further, TRE performs missing alarm analysis for out of sequence alarms and suitably updates the DSs with annotation probabilities (2345).

Continuing Example 1, upon receiving the second alarm a2, the derived segments are updated as follows: Since only annotation 1 has a2, DS1 alone is updated and DS2 and DS3 remain unchanged.

DS1=[a1, a2]

DS2=[a1]

DS3=[a9, a1]

In step 2350, TRE queries the current usecase information for the annotations containing the current alarm. If annotations are found, TRE processes the alarm from the step 2315 onwards. TRE checks and notifies DS Compete internal notification for each of DSs that completely match with an annotation (2355).

FIG. 2D-1 illustrates the procedure for processing the DS on DS complete/AMV change/transaction_end/usecase_end notifications (2360). Pending DS list is a common list of DSs, across usecases, that match completely with an annotation and has pre- and/or post-conditions yet to be satisfied. TRE checks for the notification (2361). Upon receiving transaction end or usecase end notification, TRE deletes DSs in Pending DS list whose context associated with pre- and post-conditions matches with the transaction/usecase (2362).

Upon receiving AMV change internal notification, TRE checks and updates pre-/post-conditions of all DSs in Pending DS list based on changed AMV and transfers those DSs whose pre- and post-conditions got completely satisfied to Open DS list (2363). On receiving DS complete notification, TRE updates Open DS list with the completed DS (2364).

For each DS in the Open DS list, TRE performs the following steps (2365):

Checks and updates pre- and post-conditions and annotation probability of current DS. If annotation probability is less than the threshold specified in the post condition, then the DS is deleted. If all conditions are satisfied and post-action is fault, TRE notifies BBN_TRE_FAULT_INFERRED to the blackboard (2366).

Updates pre- or post-condition of DSs in Pending DS list based on the current DS. Transfers pre- and post-condition satisfied DSs from pending DS list to Open DS list. Moves the current DS from Open DS list to Pending list (2367).

TRE checks whether Open DS list is empty (2369). If DSs exist, steps from 2365 to 2367 are performed; else DS processing is terminated.

FIG. 2E illustrates the procedure for processing BBN_AMV_CHANGE notification by TRE. TRE gets notification on AMV change (2400) and gets additional AMV information such as AMV id and AMV value from the blackboard (2405) and stores it in AMV database (2410). In addition, AMV_Change internal notification is posted.

FIG. 2F illustrates the procedure for processing of BBN_TRANSACTION_END notification by TRE (2500). Transaction end is notified to the blackboard by f-stones via SCOP and FRE. TRE performs the following steps for each of the DS in the current transaction (2502). AMV analysis for missing alarms for a DS is performed (2505). If annotation probability condition (2507) is satisfied, TRE posts an internal DS complete notification (2510), otherwise current DS is deleted (2508). After processing all the DSs, TRE posts an internal transaction end notification (2515).

FIG. 2G illustrates the procedure for processing of BBN_USECASE_END notification by TRE. F-stones notify the end of the usecase to the blackboard via SCOP and FRE. TRE gets BBN_USECASE_END notification (2600) and posts internal notification about usecase end (2605). TRE logs all alarms generated in CUi (2610).

FIG. 2H illustrates the procedure for processing BBN_FAULT_VALIDATION_REQUEST for a fault by TRE (2700). TRE reads information of one or more AMVs related to the fault from AMV database (2705). TRE analyzes the updated trend of the related AMVs by comparing it with signature trends associated with the AMV and using pre-defined rules for this AMV (2710). If the signature indicating the occurrence of the fault is detected, TRE notifies the probability of occurrence of the fault (2715). The probability of occurrence of the fault is estimated based on the extent to which the AMV trend matches with its corresponding signature.

FIG. 21 illustrates the procedure for processing of BBN_FAULT_RECTIFIED/BBN_FAULT_REJECTED notification by TRE (2800). TRE identifies pending DS list for all the DSs associated with a rectified/rejected fault and deletes them from the pending DS list (2805). The DSs associated with the rectified/rejected fault are identified by tracing backwards the chain of DSs connected by pre- or post-conditions starting with DS whose post action has led to the current fault till the starting DS of the chain ensuring that the deleted DS is not part of any other chains. Prior to deletion, TRE keeps track of the timestamps of the first alarm in the beginning of the annotation chain and the last alarm in the last annotation leading to the fault. This information is used by other REs.

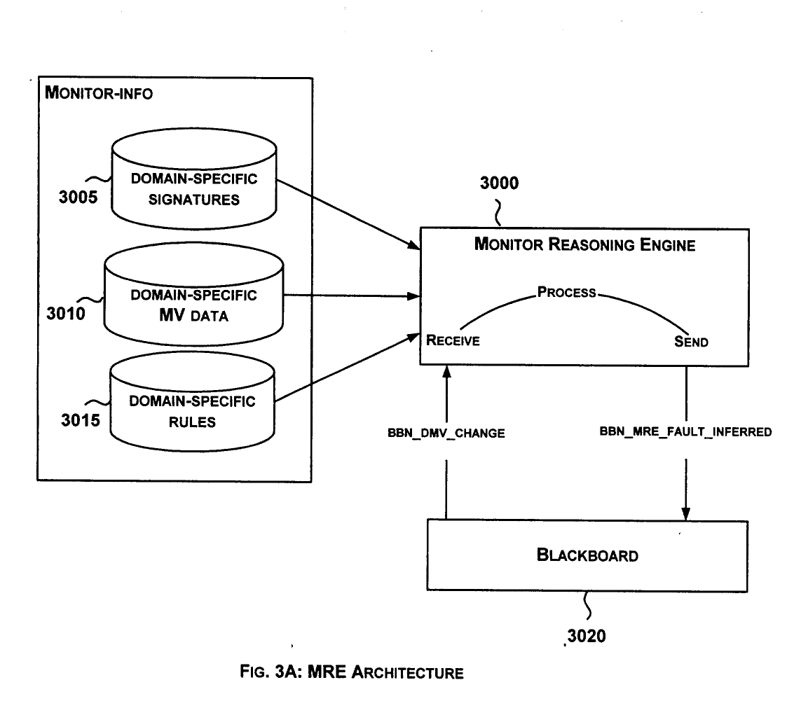

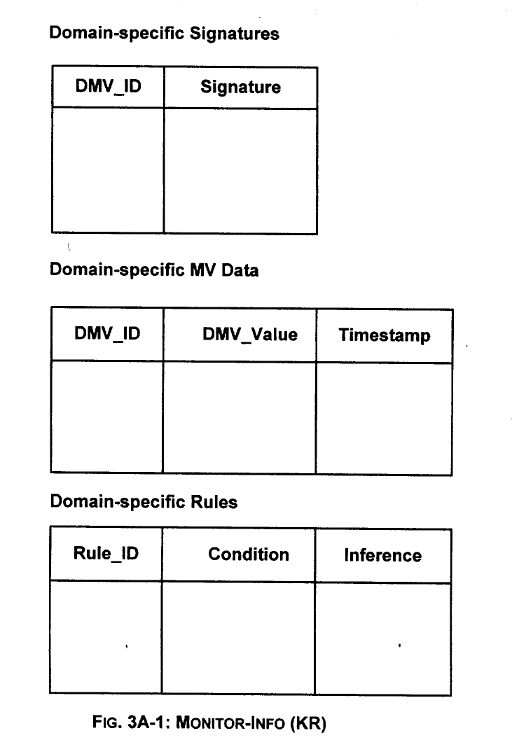

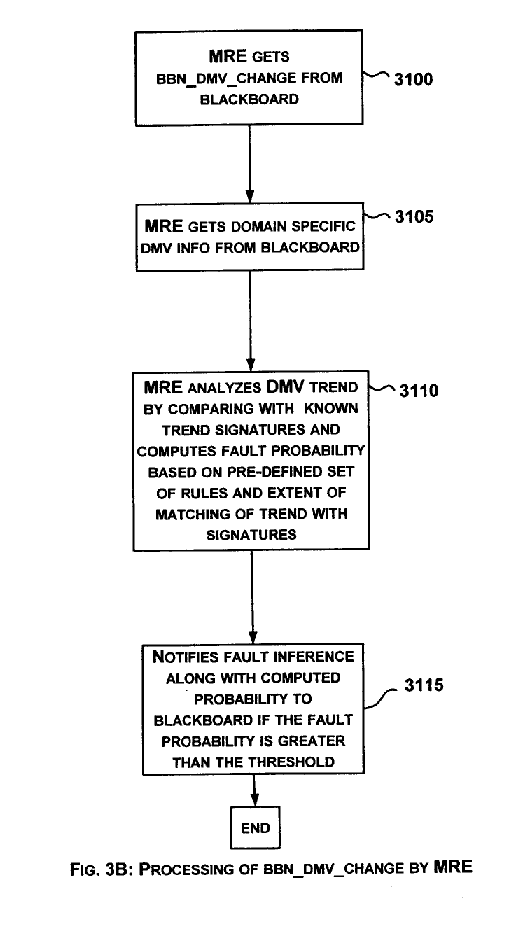

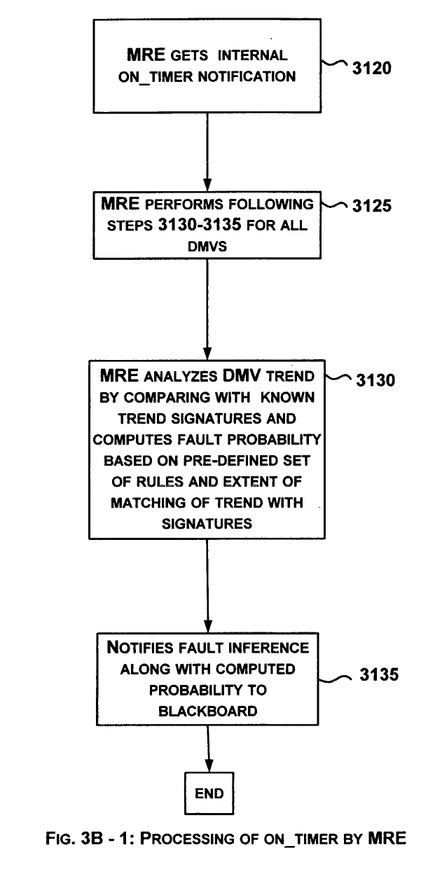

FIG. 3A illustrates the architecture of the Monitor Reasoning Engine (MRE). MRE processes the Domain-specific Monitor Variables (DMVs) to infer software and hardware faults (3000). MRE receives DMVs from SCOP via FRE. DMVs are directly associated with faults and support from DMVs is used to infer faults. MRE makes use of knowledge repository comprising of domain-specific rules knowledge base (3015), domain-specific signature database (3005), and domain-specific MV data (3010). The rules are collected during the life cycle of CES and are updated as and when the knowledge about a fault and the corresponding trend in one or more DMVs is acquired. MRE compares the result of analysis of DMVs with the stored signatures and based on the comparison estimates the probability of occurrence for the fault and if the estimated probability is greater than the specified threshold MRE notifies the occurrence of the corresponding fault, along with the estimated probability to the blackboard (3020).

FIG. 3A-1 illustrates typical data representation of monitor information as stored in KR.

FIG. 3B illustrates the procedure for processing BBN_DMV_CHANGE notification by MRE (3100). MRE reads domain-specific MV information of the notified DMV containing DMV identifier and DMV value from the blackboard (3105). MRE analyzes the DMV trend by comparing with the known trend signatures and computes the fault probability based on a pre-defined set of rules and the extent of matching of the trend with signatures (3110). Signature trends are available with domain-specific signature database. MRE notifies inferred fault to the blackboard along with the probability of occurrence, if the fault probability is greater than the specified threshold (3115).

FIG. 3B-1 illustrates the procedure for processing internal ON_TIMER notification by MRE (3120). MRE performs the following steps for each DMV (3125). MRE analyzes the DMV trend by comparing with the known trend signatures and computes the fault probability based on the pre-defined set of rules and the extent of matching of the trend with signatures (3130). Signature trends are available with domain-specific signature database. MRE notifies inferred fault to the blackboard along with the probability of occurrence, if the fault probability is greater than the specified threshold (3135).

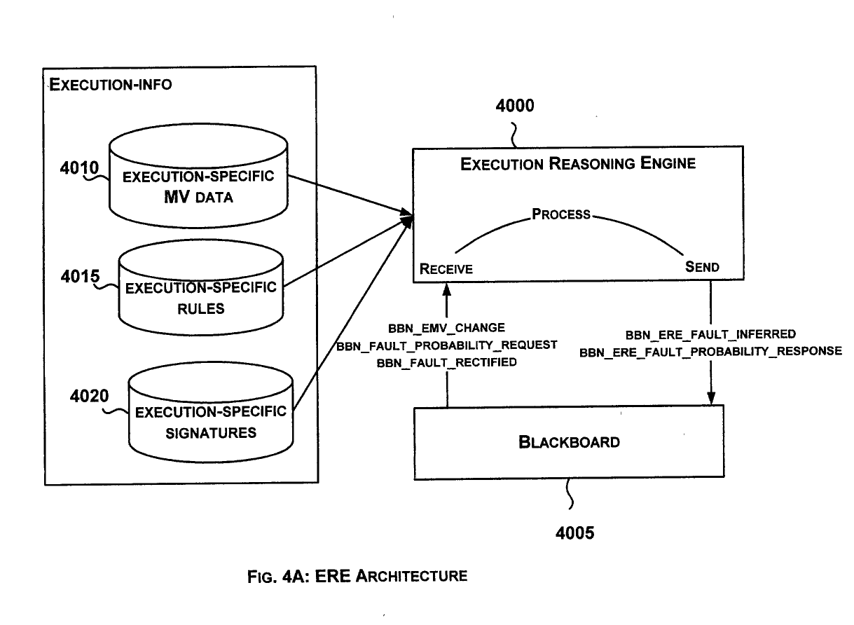

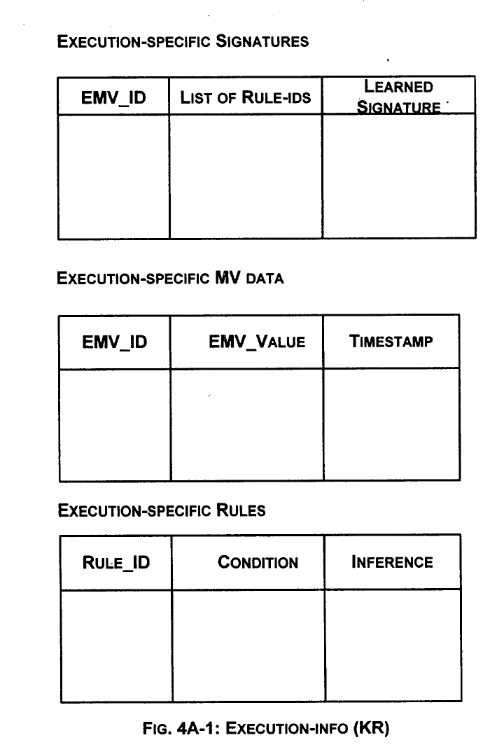

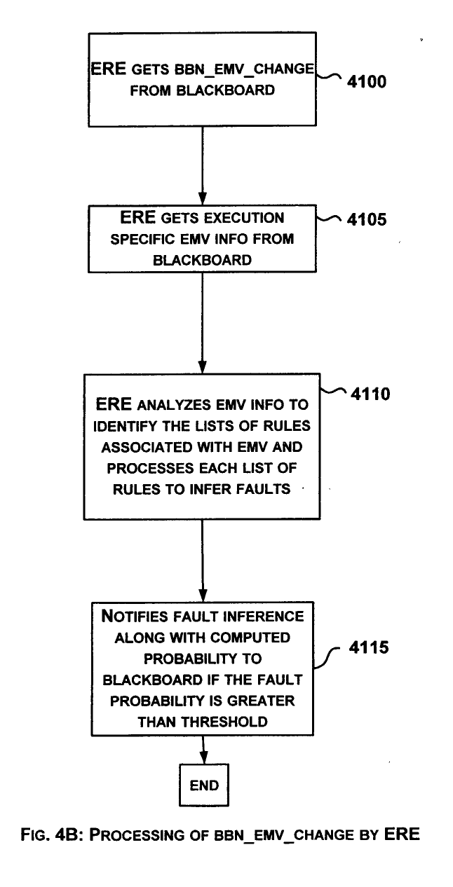

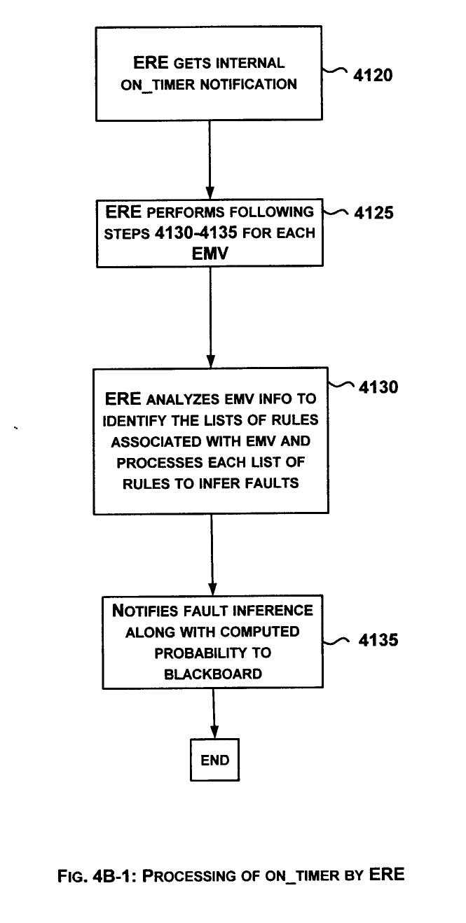

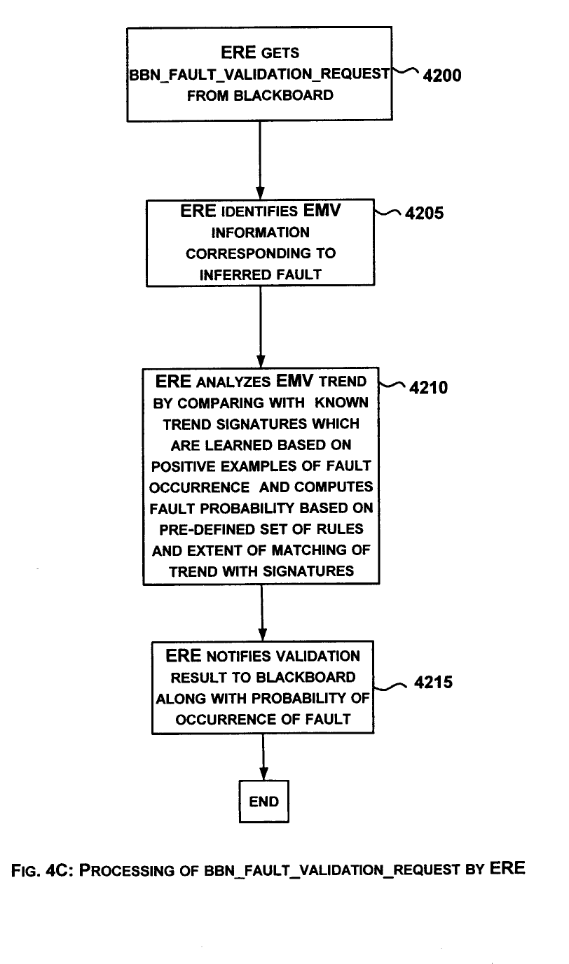

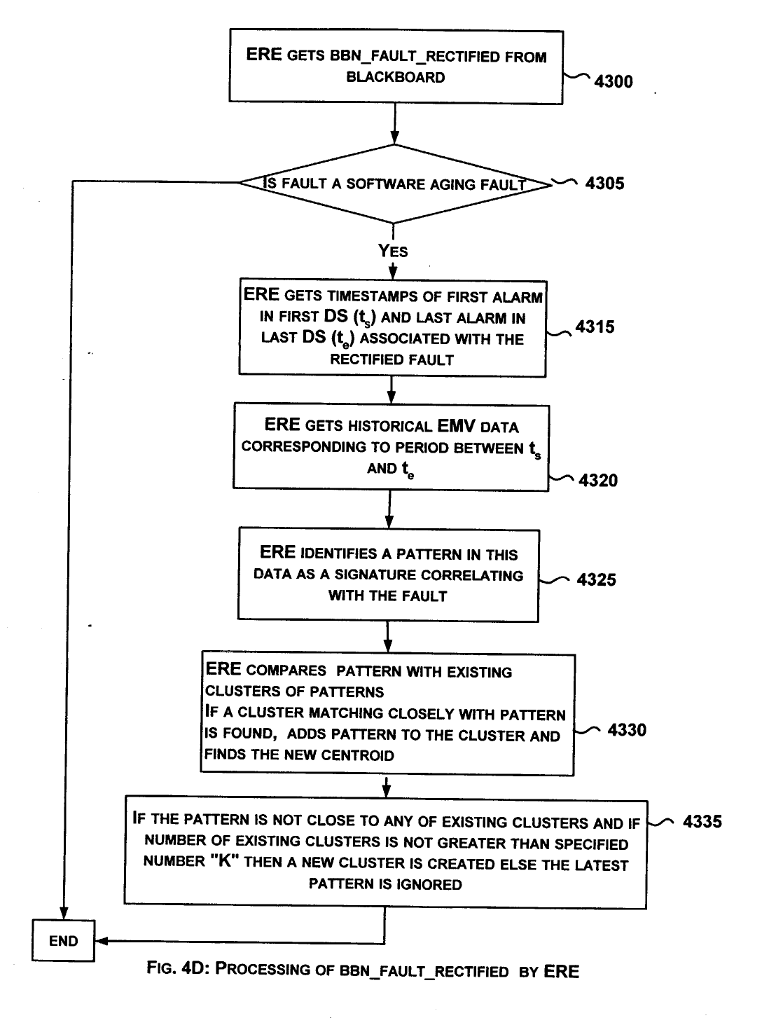

FIG. 4A illustrates the architecture of the Execution Reasoning Engine (ERE). ERE processes the execution-specific monitor variables (EMVs) to infer execution-specific/process-specific software faults (4000). ERE gets EMVs from SCOP via FRE. Execution-specific MVs are directly associated with faults and support from EMVs is used to infer faults. ERE uses the knowledge repository comprising of execution-specific rules knowledge base (4015), execution-specific signature database (4020) and execution-specific MV data (4010). ERE monitors memory and processor usage per execution thread and applies the rules on collected monitor variables to infer faults.

FIG. 4A-1 illustrates typical data representation of execution information as stored in KR.

FIG. 4B illustrates the procedure for processing BBN_EMV_CHANGE notification by ERE (4100). ERE reads execution-specific MV information of the notified the EMV, containing EMV identifier, EMV value from the blackboard (4105). ERE analyzes EMV info to identify the lists of rules associated with EMV and processes each list of rules to infer faults (4110). ERE notifies inferred fault to the blackboard along with the probability of occurrence, if the fault probability is greater than the specified threshold (4115).

FIG. 4B-1 illustrates the procedure for processing internal ON_TIMER notification by ERE (4120). ERE performs the following steps for each of the EMVs (4125). ERE analyzes the EMV info to identify the lists of rules associated with EMV and processes each list of rules to infer faults (4130). ERE notifies inferred fault to the blackboard along with the probability of occurrence, if the fault probability is greater than the specified threshold (4135).

FIG. 4C illustrates the procedure for processing BBN_FAULT_VALIDATION_REQUEST notification by ERE (4200). ERE identifies the execution-specific MV information corresponding to the inferred fault (4205). ERE analyzes EMV trend by comparing with the known trend signatures which are learned based on positive examples of fault occurrence and computes the fault probability based on the pre-defined set of rules and the extent of matching of the trend with signatures (4210). ERE notifies validation result to the blackboard along with the probability of occurrence of the fault (4215).

FIG. 4D illustrates the procedure for processing BBN_FAULT_RECTIFIED notification by ERE. On BBN_FAULT_RECTIFIED notification ERE checks if the fault is a software aging fault (4305). If it is a software aging fault, ERE initiates learning of EMV signature-fault correlation model. Following are the steps in the learning procedure.

1. Gets the timestamps of the first alarm in the first DS (tₛ) and last alarm in the last DS (tₑ) associated with rectified fault from the blackboard (4315).

2. Collects the EMV data corresponding to the period between these time stamps (tₛ and tₑ) (4320).

3. Identifies a pattern in this data as a signature correlating with the fault (4325).

4. ERE compares pattern with existing clusters of patterns and adds to the cluster closely matching and finds the new centroid (4330).

5. If the pattern is not close to any of existing clusters and if number of existing clusters is not greater than specified number “K”, then a new cluster is created else the latest pattern is ignored (4335).

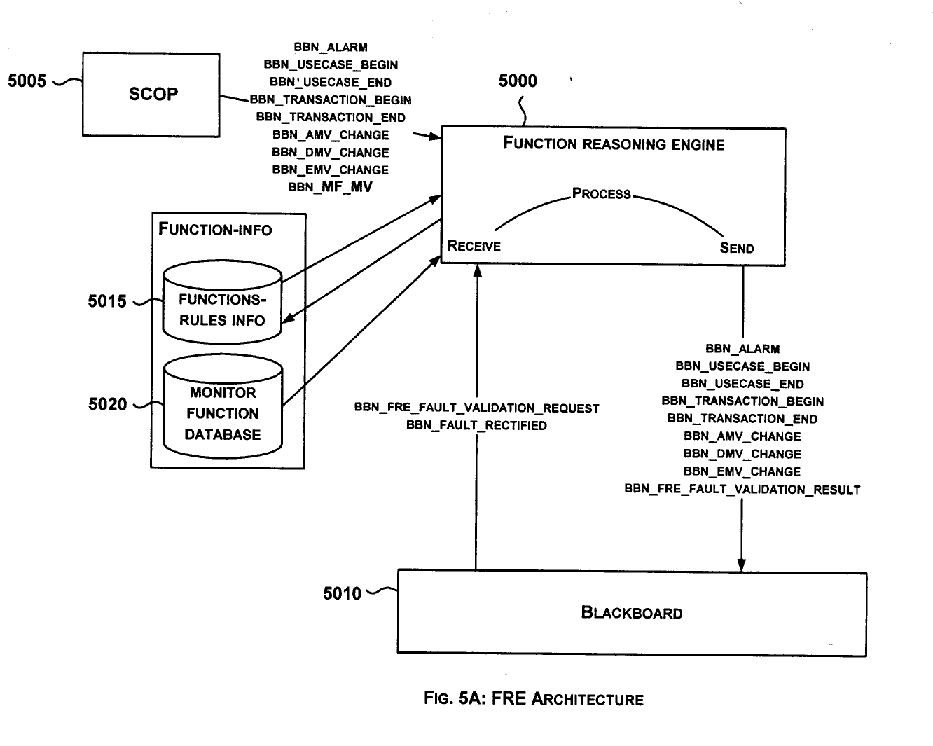

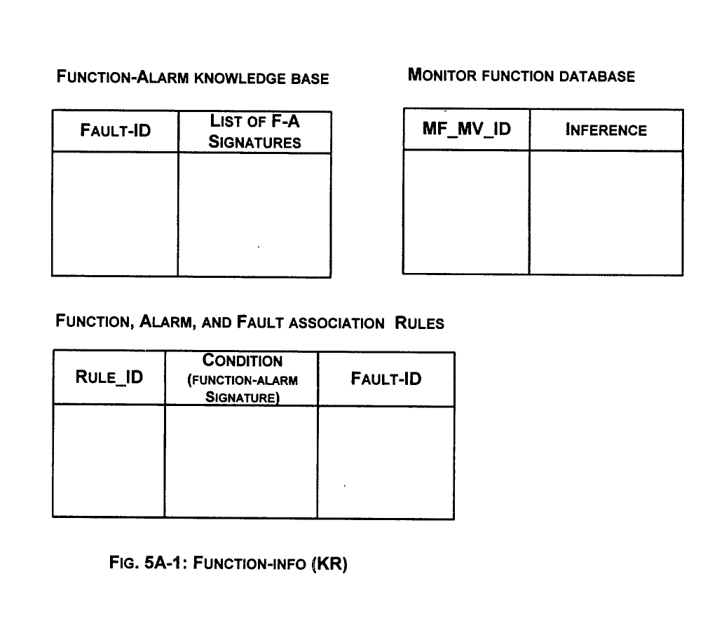

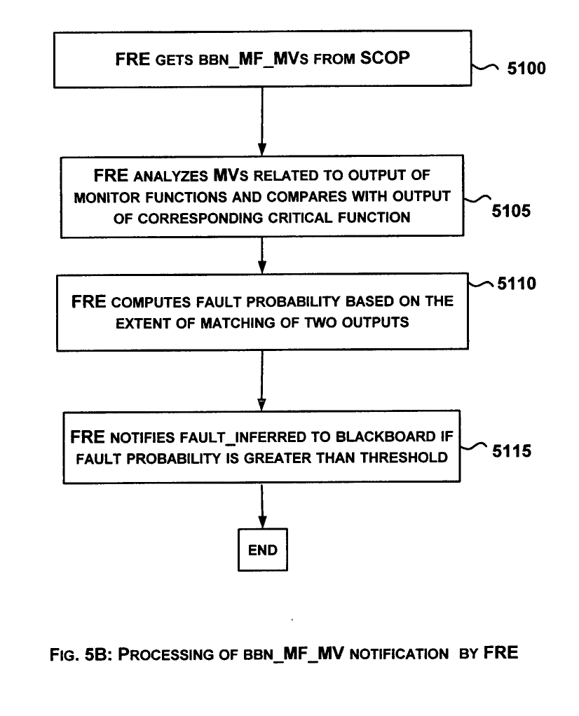

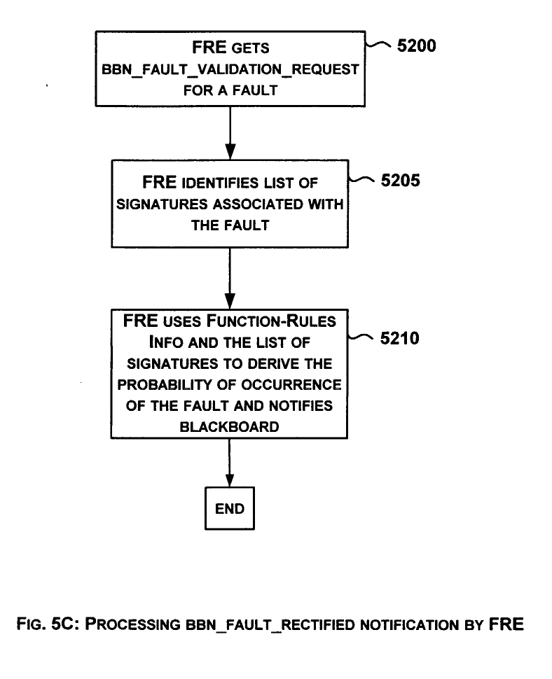

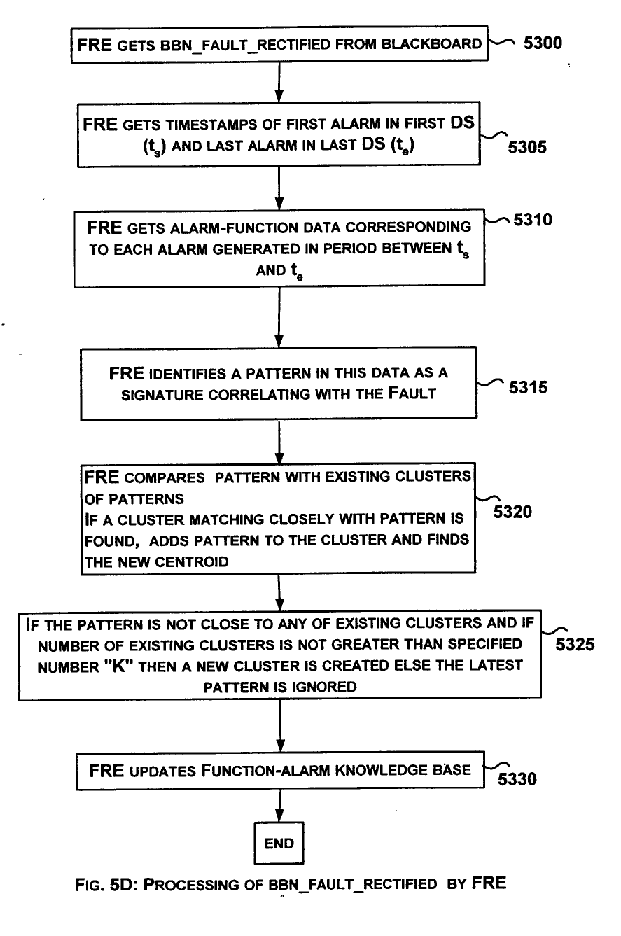

FIG. 5A illustrates the architecture of the Function Reasoning Engine (FRE). FRE acts as an interface between SCOP and the blackboard (5000). FRE interacts with SCOP to collect the information from CES (5005), and provides the information to the blackboard (5010). FRE validates a fault based on the correlation between an alarm in a function with the fault. Functions-Rules Info consists of rules correlating the function-alarm combination to specific faults (5015). Monitor function database consists for MVs related to critical functions (5020).

Following are the notifications sent to the blackboard by FRE based on the information collected from SCOP:

BBN_ALARM

BBN_USECASE_BEGIN

BBN_USECASE_END

BBN_TRANSACTION_BEGIN

BBN_TRANSACTION_END

BBN_AMV_CHANGE

BBN_DMV_CHANGE

BBN_EMV_CHANGE

FIG. 5A-1 illustrates typical data representation of function information as stored in KR.

FIG. 5B illustrates the procedure for processing BBN_MF_MV notification by FRE. FRE gets the BBN_MF_MV notification from SCOP (5100). FRE analyzes the MVs related to output of monitor functions and compares with the output of the corresponding critical function (5105). FRE computes the fault probability based on the extent of matching of the two outputs (5110). FRE posts the fault-inferred notification to the blackboard if the fault probability is greater than a threshold (5115).

FIG. 5C illustrates the procedure for processing BBN_FAULT_VALIDATION_REQUEST notification for a fault by FRE (5200). FRE identifies the list of signatures associated with the fault from Function-Alarm knowledge base (5205). FRE uses Function-Rules Info and the list of signatures to derive the probability of occurrence of the fault and notifies blackboard (5210).

FIG. 5D illustrates the procedure for processing BBN_FAULT_RECTIFIED notification by FRE (5300). FRE initiates learning of alarm-function signature correlation with the fault. Following are the steps in the learning procedure:

1. FRE gets timestamps of first alarm in first DS (tₛ) and last alarm in last DS (tₑ) (5305).

2. FRE gets alarm-function data corresponding to each alarm generated in period between tₛ and tₑ (5310).

3. FRE identifies a pattern in this data as a signature correlating with the fault (5315).

4. FRE compares the pattern with existing clusters of patterns. If a cluster matching closely with the pattern is found, adds the pattern to the cluster and finds the new centroid (5320).

5. If the pattern is not close to any of existing clusters and if number of existing clusters is not greater than the specified number “K”, then a new cluster is created else the latest pattern is ignored (5325).

6. FRE updates Function-alarm knowledge base (5330).

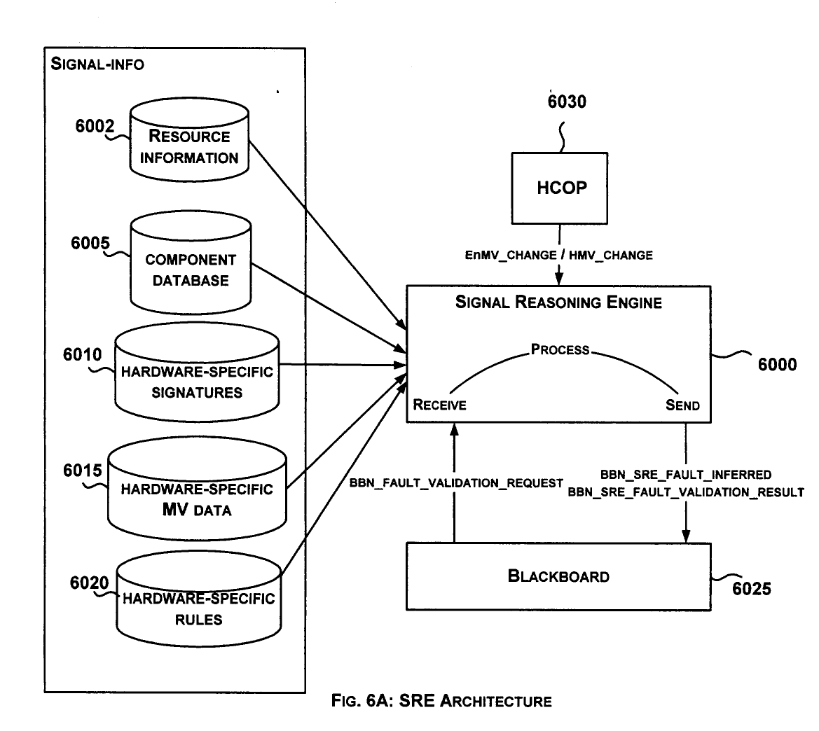

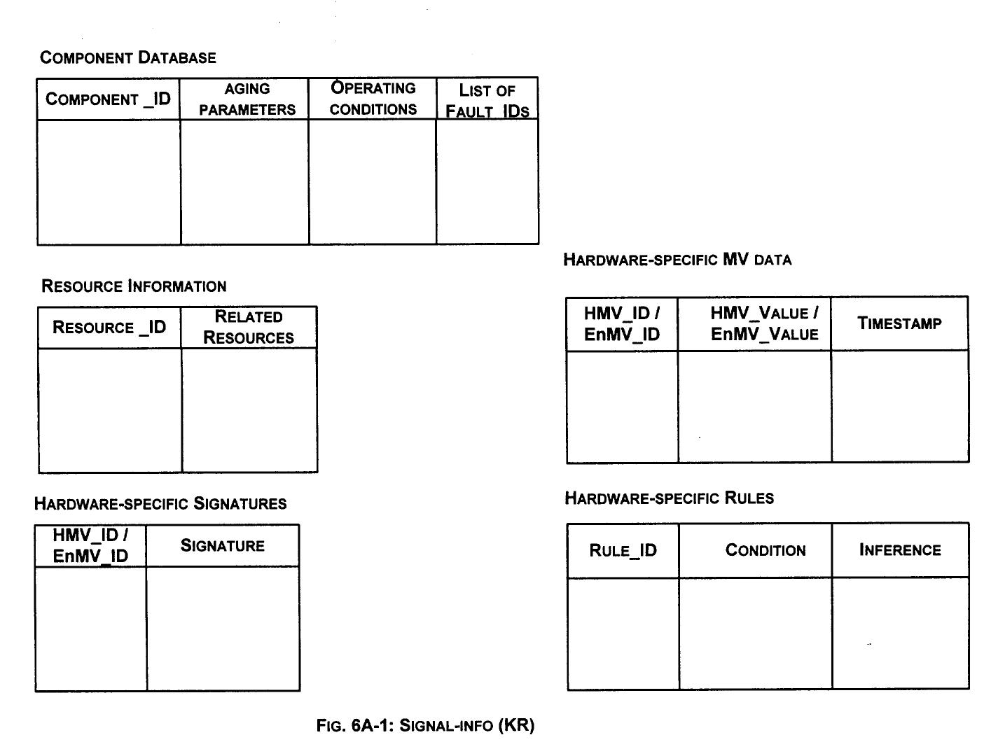

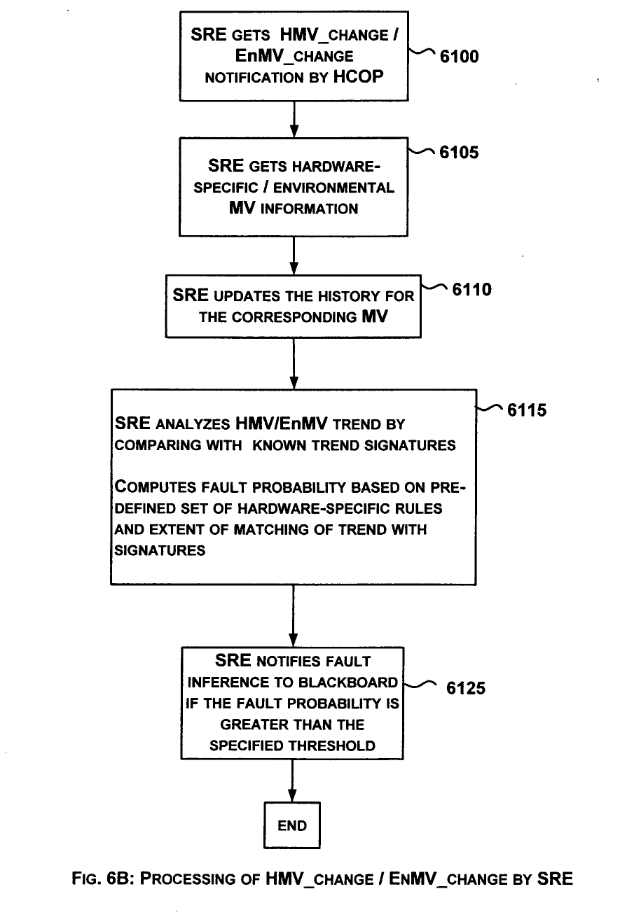

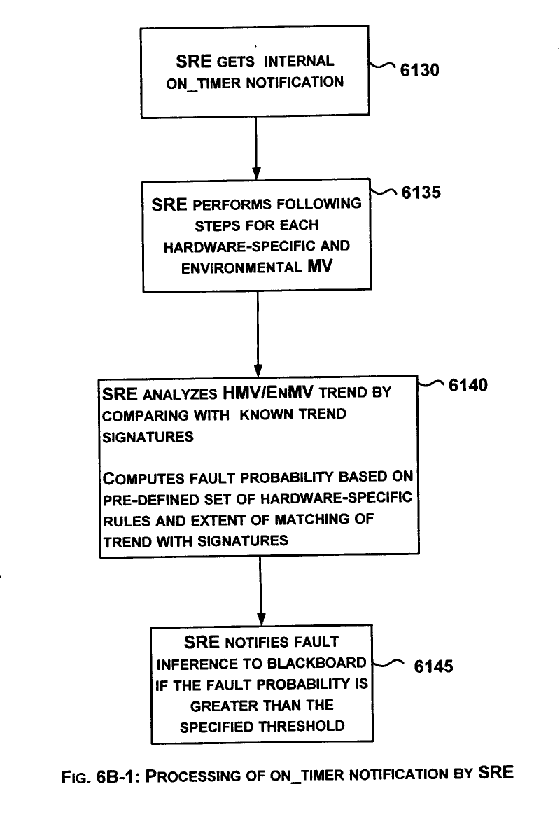

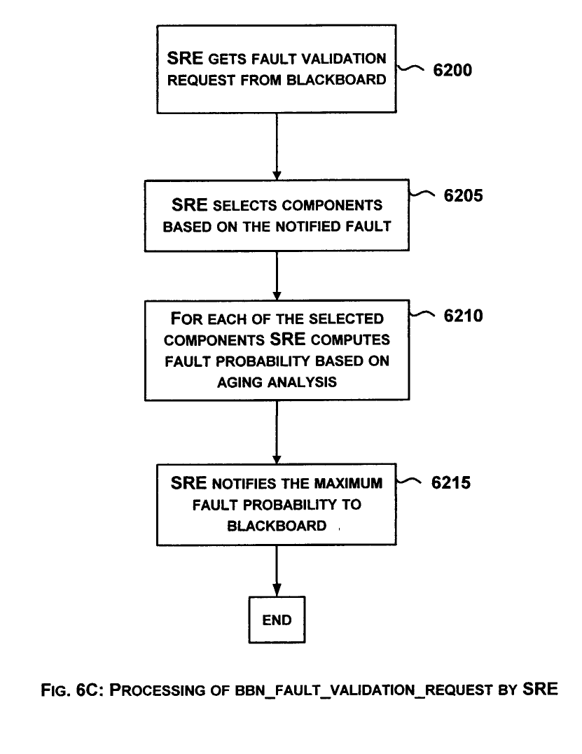

FIG. 6A illustrates the architecture of the Signal Reasoning Engine (SRE) (6000). SRE receives the hardware and environmental related monitor information from HCOP (6030). SRE identifies and validates the hardware faults based on hardware-specific MV analysis and aging analysis and notifies the blackboard (6025). SRE's knowledge repository comprises of Resource Information (6002), component database (6005), hardware-specific rules knowledgebase including operating conditions of the components (6020), hardware-specific signature database (6010) and hardware-specific MV data (6015). The procedure for processing the information from HCOP to identify and validate the hardware faults by SRE is explained below.

FIG. 6A-1 illustrates typical data representation of signal information as stored in KR.

FIG. 6B illustrates the procedure for processing of HMV_CHANGE/EnMV_CHANGE notification by SRE (6100). SRE gets HMV change or EnMV change notification by HCOP (6105). SRE gets the hardware-specific and environmental MV information from the blackboard. SRE updates the MV data for the corresponding MV (6110). SRE analyzes HMV/EnMV trend by comparing with known trend signatures and computes fault probability based on pre-defined set of hardware-specific rules and extent of matching of trend with signatures (6115). SRE notifies fault inference to the blackboard if the fault probability is greater than the specified threshold (6120).

FIG. 6B-1 illustrates the procedure for processing of internal ON_TIMER NOTIFICATION by SRE (6130). SRE performs the following for each HMV and EnMV (6135). SRE analyzes the HMV/EnMV trend by comparing with known trend signatures and computes the fault probability based on the pre-defined set of hardware-specific rules and extent of matching of trend with signatures (6140). SRE notifies the fault inference to the blackboard if the fault probability is greater than the specified threshold (6145).

FIG. 6C illustrates the procedure for processing BBN_FAULT_VALIDATION_REQUEST notification by SRE (6200). SRE selects the components based on the notified fault (6205). For each of the selected components SRE computes fault probability based on the aging analysis (6210). SRE notifies the maximum of the computed fault probabilities to the blackboard (6215).

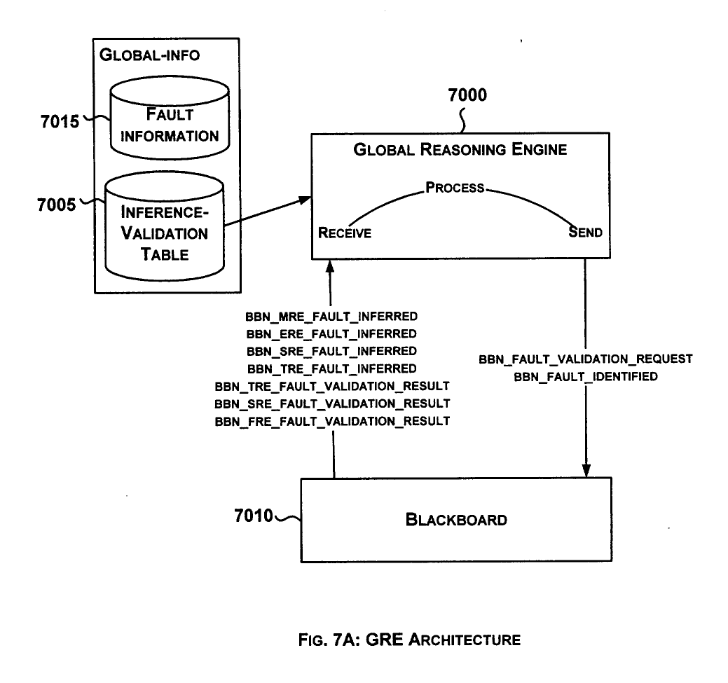

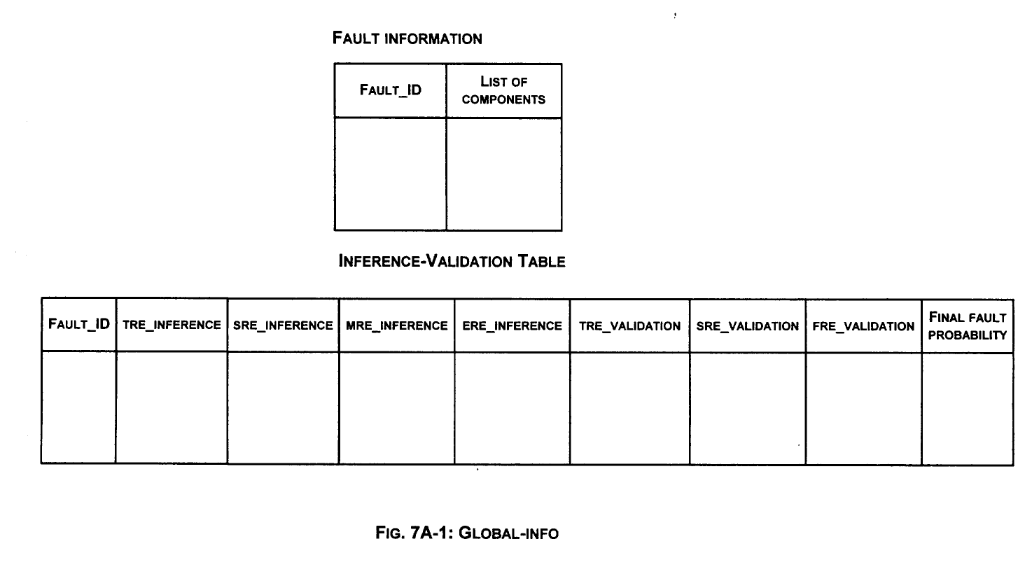

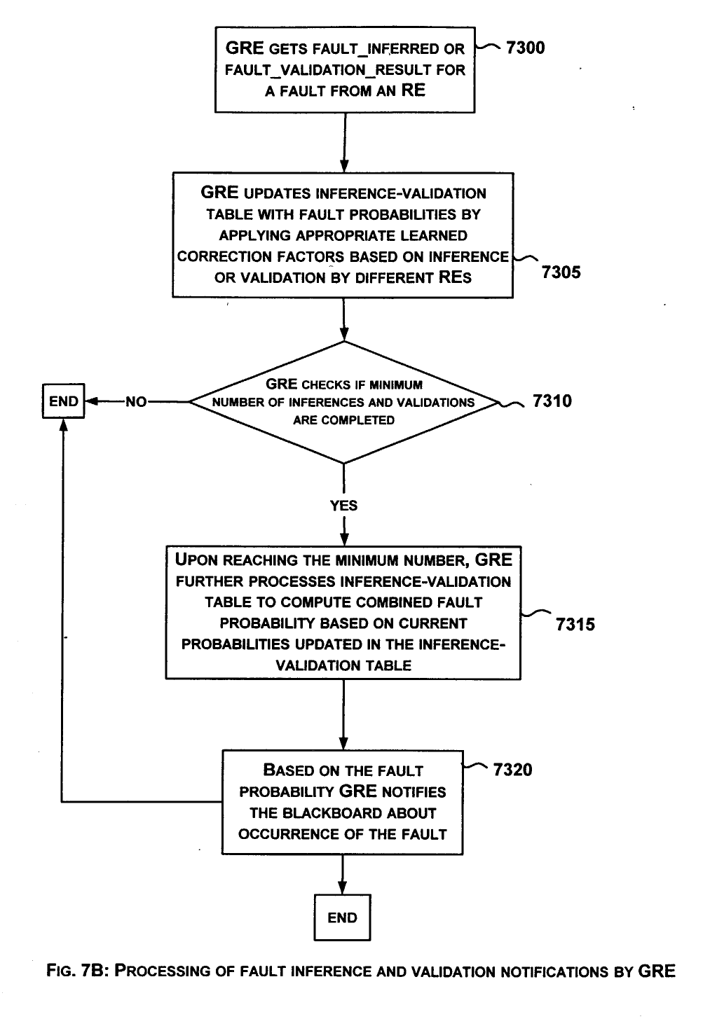

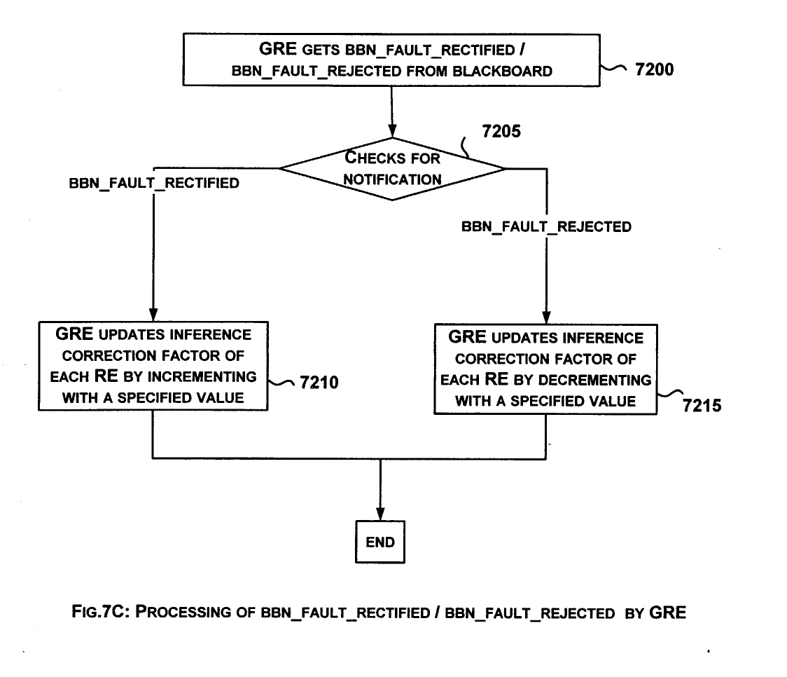

FIG. 7A illustrates the architecture of the Global Reasoning Engine (GRE) (7000). GRE keeps track of a fault inferred by an RE, and requests the remaining REs to validate the fault. For each fault identified, GRE computes the final fault probability based on majority voting. Global-Info comprising of fault inference-validation table (7005) and Fault information (7015) is the knowledge repository of GRE.

FIG. 7A-1 illustrates typical data representation of global information as stored in KR.

FIG. 7B illustrates the procedure for processing BBN_MRE_FAULT_INFERRED, BBN_ERE_FAULT_INFERRED, BBN_SRE_FAULT_INFERRED, BBN_TRE_FAULT_INFERRED, BBN_TRE_FAULT_VALIDATION_RESULT, BBN_SRE_FAULT_VALIDATION_RESULT, BBN_ERE_VALIDATION_RESULT AND BBN_FRE_FAULT_VALIDATION_RESULT notifications by GRE (7300). GRE updates the inference-validation table with fault probabilities by applying appropriate learned correction factors based on the inference or validation by different REs (7305). GRE updates the inference-validation table for the inferred probability only if the latest inferred fault probability by an RE is greater than the fault probability previously posted by the same RE in the inference-validation table. GRE checks if a minimum number of inferences and validations are available (7310). Upon reaching the minimum number, GRE further processes inference-validation table to compute combined fault probability based on current probabilities updated in the inference-validation table (7315). Based on the fault probability GRE notifies the blackboard about occurrence of the fault (7320).

FIG. 7C illustrates the procedure for processing BBN_FAULT_RECTIFIED/BBN_FAULT_REJECTED notifications by GRE (7200). GRE checks for the notification (7205). If the notification is BBN_FAULT_RECTIFIED, GRE updates inference correction factor of each RE by incrementing with a specified value (7210). If the notification is BBN_FAULT_REJECTED, GRE updates inference correction factor of each RE by decrementing with a specified value.

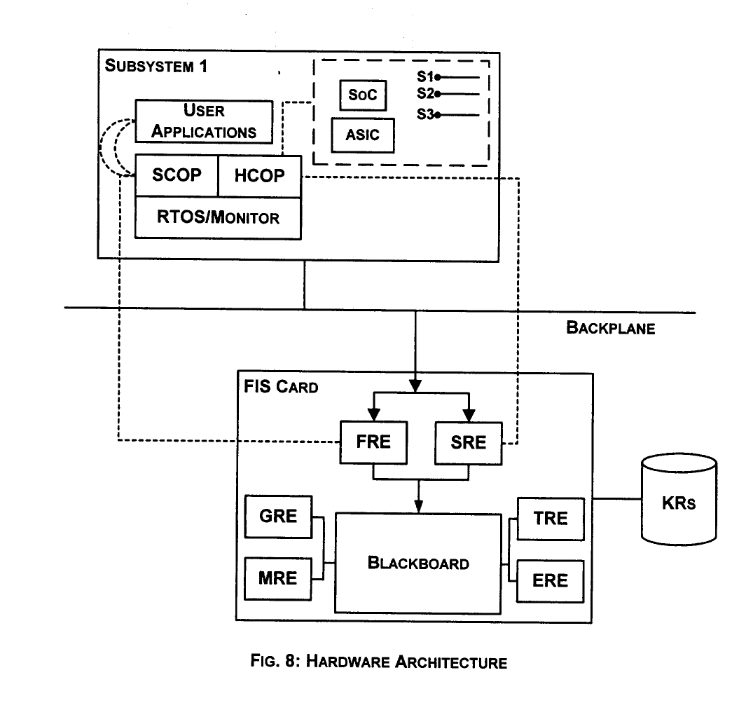

FIG. 8 illustrates the hardware architecture of the fault identification system (FIS). FIS is an independent hardware, integrated with the core electronic system. Each hardware-software component in the core electronic system is designed for diagnosis, meaning that nano-agents and f-stones along with SCOP and HCOP are implemented to provide the information for diagnosis. These components of the core electronic system communicate with the FIS card over system backplane.

Another preferred embodiment of this invention covers the aspect of design for diagnosis (DFD). Design for diagnosis is aimed to minimize MTTR by designing the CES to provide maximum additional contextual information for the alarms generated, thus enhancing the precision with which the faults can be diagnosed within a minimum amount of time.

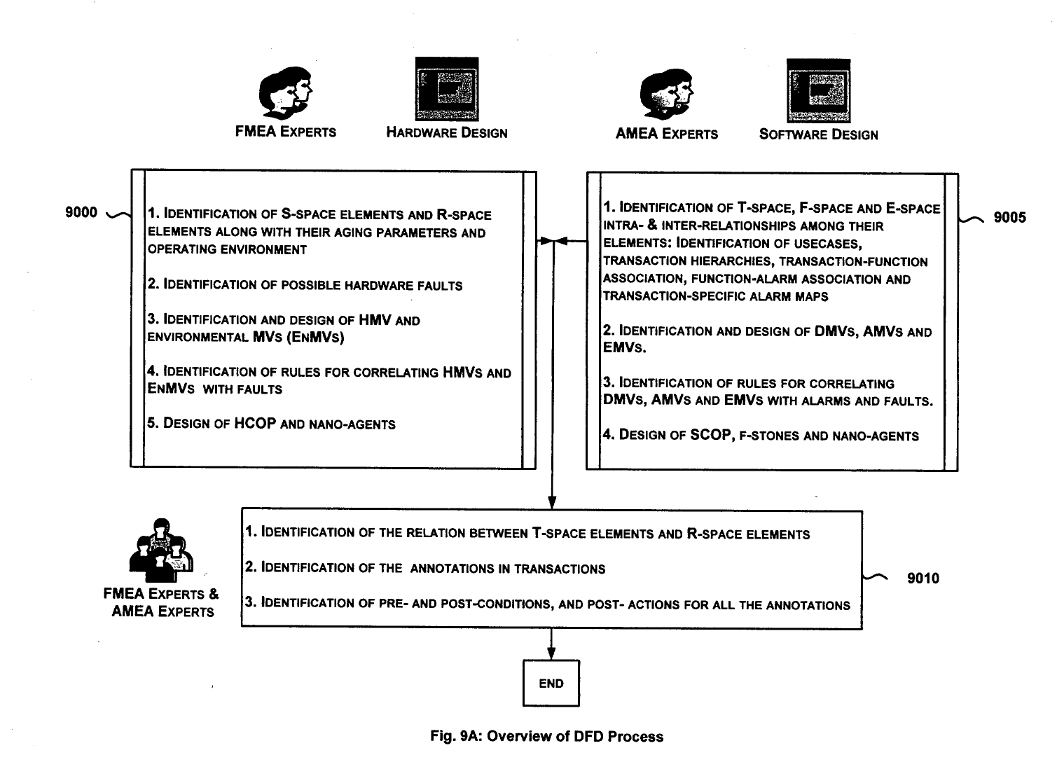

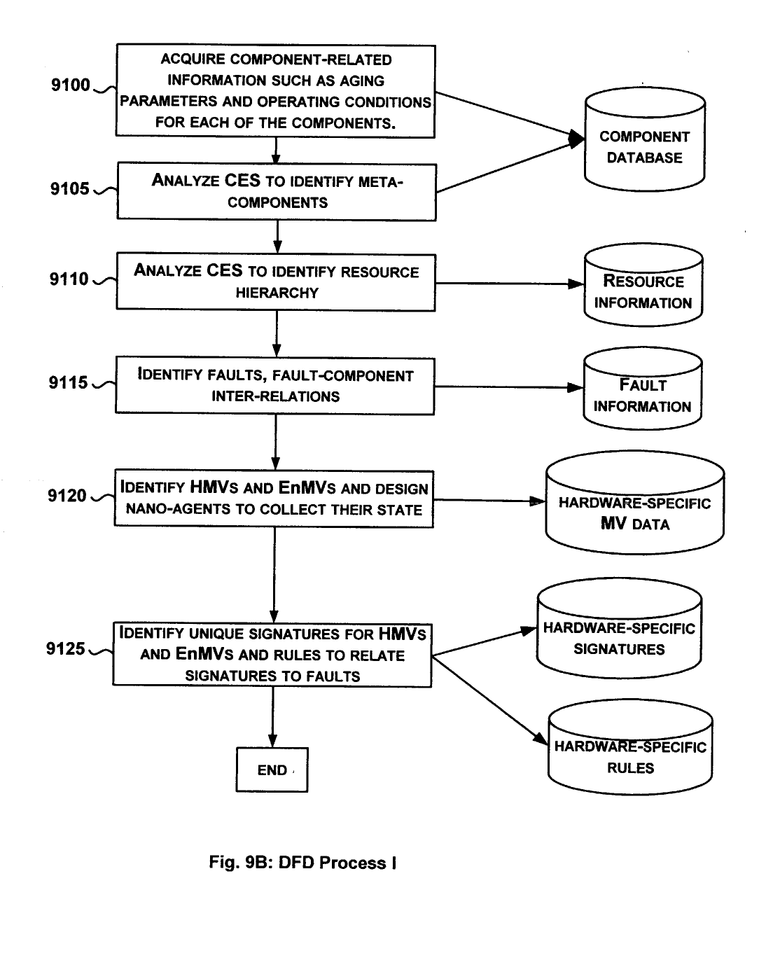

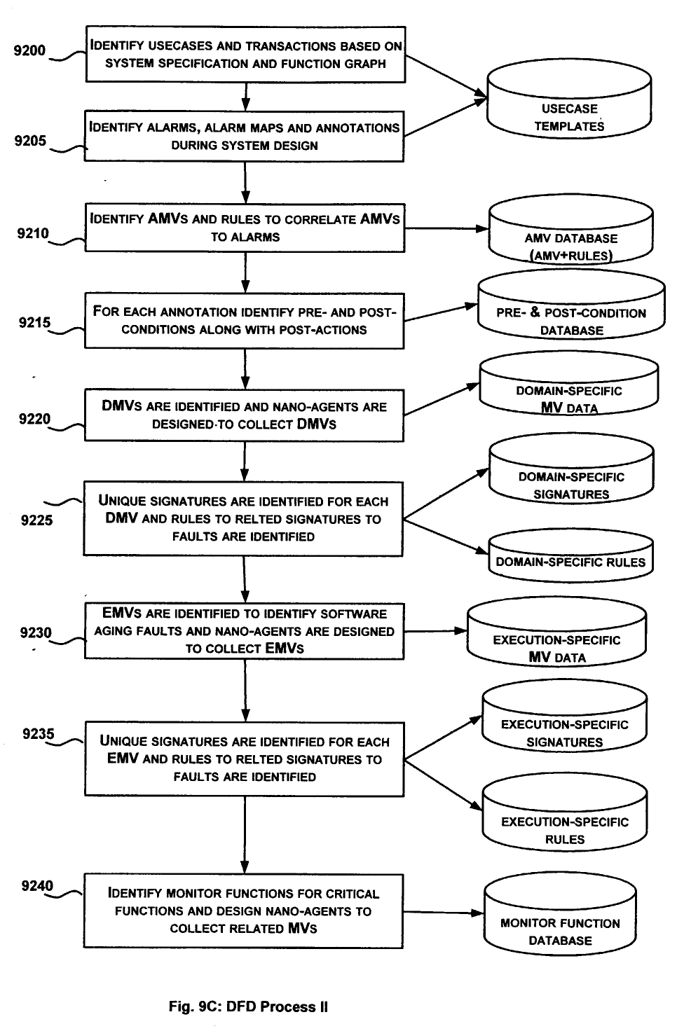

FIG. 9A illustrates the overview of the DFD process. One phase of the DFD addresses hardware issues related to efficient diagnosis. During hardware design of CES, a group of experts, specialized in failure mode and effective analysis (FMEA), performs the following (9000):

1. Identification of S-space elements and R-space elements along with their aging parameters and operating environment;

2. Identification of possible hardware faults;

3. Identification and design of HMV and environmental MVs (EnMVs);

4. Identification of rules for correlating HMVs and EnMVs with faults; and

5. Design of HCOP and nano-agents.

Another phase of the DFD addresses software related diagnostic issues. During software design of CES, a group of experts, specialized in alarm management and effective analysis (AMEA), performs the following (9005);

1. Identification of T-space, F-space and E-space intra- & inter-relationships among their elements: Identification of usecases, transaction hierarchies, transaction-function association, function-alarm association and transaction-specific alarm maps;

2. Identification and design of DMVs, AMVs and EMVs;

3. Identification of rules for correlating DMVs, AMVs and EMVs with alarms and faults; and

4. Design of SCOP, f-stones and nano-agents.

A joint analysis by FMEA experts and AMEA experts results in the following (9010):

1. Identification of the relation between T-space elements and R-space elements;

2. Identification of annotations associated with transactions; and

3. Identification pre- and post-conditions, and post-actions for all the annotations.

DFD approach is an enhanced hardware-software co-design methodology to improve the diagnosibility of the system. The enhancements are along two directions:

1. The process of fault identification by FIS makes use of several knowledge and databases. The extension to the methodology is to describe steps involved in collecting this required information

2. The run-time environment of FIS requires specific functionality to be implemented as part of CES. Examples of such functionality include nano-agents and f-stones.

FIG. 9B illustrates the key steps involved in the DFD process I are provided below:

1. Component selection: During system design, various components that are used in the design of a hardware subsystem are identified. FIS requires component-related information such as aging parameters and operating conditions for each of the components. This information is acquired during the hardware design step and is updated onto Component database (9100).

2. Meta component: A set of related components form a meta component. System is analyzed to identify meta-components such as SoCs and ASICs, and these components are designed to ensure that the required information related to component behavior are made available. This information is obtained during run-time through the standard interfaces such as JTAG (9105).

3. Resource hierarchy: FIS requires the inter-relation among the resource elements. System is analyzed to identify resource hierarchy in terms of different levels such as component-meta-component- and board-level. This information is updated onto Resource Information database (9110).

4. Fault identification: Faults are identified during FMEA analysis phase. This activity is extended to identify the fault-component inter-relations. The information acquired during this step is updated onto Fault Info database (9115).

5. Monitor variables (HMVs and EnMVs): FIS uses monitor variables to infer faults. These monitor variables provide additional support information for occurrence or non-occurrence of faults. For each of the identified faults, appropriate hardware-specific monitor variables (HMV) and environment specific monitor variables (EnMV) are identified. An HMV is identified by analyzing the input and output of a component associated with a fault and selecting the most appropriate input and/or output whose state or a sequence of states provide additional support for the fault. FIS obtains such a sequence of states through the sensors specifically incorporated for this purpose. Similarly, an EnMV is identified by analyzing the effect of environment and operating conditions on a component behavior. This information is updated onto Hardware-Specific MV database (9120).

6. Nano-agents, rules and signatures: For each of the identified HMVs and EnMVs, appropriate nano-agents are designed to collect the state information of these monitor variables from hardware and provide them to HCOP. Unique signatures for MVs are derived wherever possible using information such as system and component specifications and rules are identified to relate these MVs signatures to faults. This information is updated onto Hardware-Specific Signatures database and Hardware-Specific Rules database (9125).

The key steps involved in the DFD process II are provided below.

7. Usecase and transaction identification: Usecases are identified during software analysis phase based on the required functionality. The function graph associated with a usecase is analyzed to identify transactions. A transaction is a logical grouping of the functions that is a part of a function graph and gets executed in a single thread or process. The transaction hierarchy of a useacse is derived based on the associated transactions and function graph. This information is updated onto Usecase Templates database (9200).

8. Alarms, maps and annotations: Alarms are identified during the system design based on the system specification and design methodology. During the software design, the functions are designed to generate the alarms under specified conditions. Transaction based alarm maps are identified by analyzing the inter-relations such as temporal relations among the alarms within a transaction. Alarms are logically grouped into annotations based on the derived alarm map. This information is updated onto Usecase Templates database (9205).

9. Monitor variables (AMVs): FIS uses AMVs to reason about missing alarms. The support for an alarm is incorporated in parts along the path of data flow starting from a kernel function and upwards till the function in which the alarm is generated. Further, one or more rules are defined that reason with these partial supports to provide a consolidated support or otherwise for the alarm. This information is updated onto AMV database (9210).

10. Pre- and post-conditions; and post-actions: Pre- and post-conditions impose context-based temporal constraints on annotations. In deterministic scenarios, pre-conditions are required to be satisfied before the completion of an annotation and post-conditions to follow the completion of the annotation. On the other hand, in non-deterministic scenarios, pre- and post-conditions are together treated as rule-condition. Some of the pre- and post-conditions, and post-actions of annotations are derived based on the relationship of the annotations from the point of view of transaction hierarchy. Relationship of the annotations across usecases, from the point of view of resource hierarchy, is imposed by incorporating the AMVs of the corresponding alarms in pre- and/or post-conditions. The chain of annotations connected by post-action annotations are analyzed from fault perspective to determine sub-chains that lead to fault inference. These fault inferences are made part of appropriate post-actions. This information is updated onto Pre- and Post-condition database (9215).

11. Monitor variables (DMVs): FIS uses monitor variables to infer faults. These monitor variables provide additional support information for occurrence or non-occurrence of faults. For each of the identified faults, appropriate Domain Specific monitor variables (DMV) are identified wherever applicable based on the analysis of domain specific system information. Data flow from a kernel function upwards is analyzed upto a function wherein the fault manifestation is noticeable and one or more DMVs are identified and introduced in appropriate functions along the path. This information is updated onto Domain-Specific MV database (9220).

12. f-stones, nano-agents, rules and signatures: f-stones are identified based on the requirement of contextual information and implemented in the function to provide the contextual information related to usecase and transaction. For each of the identified DMVs, appropriate nano-agents are designed to collect the state information of these monitor variables and provide them to SCOP. Unique signatures for MVs are derived wherever possible using information such as system specification and component characteristics, and rules are identified to relate the signatures of the MVs to faults. This information is updated onto Domain-Specific Signatures database and Domain-Specific Rules database (9225).

13. Monitor variables (EMVs): FIS uses EMVs to identify software aging faults such as faults due to over utilization of CPU or memory. Various system resource parameters are studied to determine lower- and upper-bound limits from the point of view the system specification and system design decisions. Adequate number of EMVs are define to monitor critical system resources. This information is updated onto Execution-Specific MV database (9230).

14. Nano-agents, rules and signatures: For each of the identified EMVs, appropriate nano-agents are designed to collect the state information of these monitor variables and provide them to SCOP. Unique signatures for MVs are derived wherever possible using information such as system specification and rules are identified to relate the signatures of the MVs to faults. This information is updated onto Execution-Specific Signatures database and Execution-Specific Rules database (9235).

15. Software monitor functions: FIS uses monitor functions to identify software faults. The need for software monitor functions are identified based on criticality of the various functions. The criticality of the function is based on the factors such as sensitivity to input data and impact on system behavior. For each of the identified critical functions, monitor functions are designed. Suitable nano-agents are designed as part of a monitor function to provide crucial parameter for critical software functions and are so designed to collect the monitor function state information and provide the same to SCOP. Rules are designed to reason with the state information of a critical function and the corresponding monitor function to assess the critical function behavior. This information is updated on to Monitor Function database (9240).

16. Signatures and rules associated monitor variables are determined based on the system simulation results, and operation and test results of a system prototype. This information is updated onto related signatures and rules databases.

Acronyms and Definitions

1. ηAs Nano-Agents

2. AM Alarm Map

3. AMEA Alarm mode and effective analysis

4. AMV Alarm-related Monitor Variable

5. AP Annotation probability

6. ASIC Application Specific Integrated Chip

7. BB Blackboard

8. BBN The blackboard Notification

9. CES Core Electronic System

10. CIC Contextual Information Collection

11. CU Current Usecase

12. DFD Design for Diagnosis

13. DMV Domain-specific Monitor Variable

14. DS Derived Segment

15. EMV Execution-specific Monitor Variable

16. EnMV Environmental-related Monitor Variable

17. ERE Execution reasoning engine

18. ES Electronic System

19. E-space Execution space

20. FIS Fault identification system

21. FMEA Failure mode and effective analysis

22. FRE Function reasoning engine

23. F-space Function space

24. f-stones Function-stones

25. GRE Global reasoning engine

26. HCOP Hardware information collection

27. HMV Hardware-specific Monitor Variable

28. KF Kernel Function

29. KT Kernel Transaction

30. MRE Monitor reasoning engine

31. MV Monitor Variable

32. RE Reasoning engine

33. SCOP Software information collection

34. SoC System-on-Chip

35. SRE Signal reasoning engine

36. S-space Signal space

37. TRE Transaction reasoning engine

38. T-space Transaction space

What is claimed is:

1. A fault identification system, for efficiently identifying the faults occurring in a core electronic system based on the analysis of the observed alarm information and the state of hardware and software subsystems, comprising of means for reducing the ambiguity and complexity arising due to the enormity of the alarms generated by the core electronic system and further comprising of:
(a) a subsystem, TRE, for processing the alarms using the analysis of transaction-space related contextual information;
(b) a subsystem, FRE, for analyzing the function-space related contextual information;
(c) a subsystem, ERE, for analyzing the execution-space related contextual information;
(d) a subsystem, SRE, for analyzing the signal-space related contextual information;
(e) a subsystem, MRE, for analyzing monitor variable information;
(f) a subsystem, GRE, for identifying faults based on the moderation of results posted by other subsystems;
(g) a subsystem, BB, to facilitate collaboration among the subsystems; and
(h) a subsystem, CIC, for the collecting alarm and associated contextual space information in terms of four dimensional spaces, namely, Transaction-space, Function-space, Execution-space and Signal-space.

2. The system of claim 1, wherein said TRE subsystem, comprises of a procedure for transaction-wise alarm processing.

3. The system of claim 2, wherein said TRE subsystem further comprises of a procedure for usecase-wise alarm processing.

4. The system of claim 2, wherein said TRE subsystem further comprises of a procedure to use inter-relation within alarms as alarm maps and groups of alarms with temporal relation as annotations for alarm processing.

5. The system of claim 2, wherein said TRE subsystem further comprises of a procedure for analyzing monitor variables specific to an alarm wherein the behavior of the alarm-specific monitor variable provides support for the inference of a fault or occurrence of the alarm.

6. The system of claim 2, wherein said TRE subsystem further comprises of a procedure to use a set of rules, associated with each annotation as pre- and post-condition, and post-action for the annotation, for alarm processing.

7. The system of claim 2, wherein said TRE subsystem further comprises of a procedure to use the knowledge repository of plurality of information comprising of transaction information, usecase information, alarm maps, annotation information, pre- and post-conditions, and post-actions associated with each of the annotations, and AMV data and associated rules for alarm processing.

8. The system of claim 2, wherein said TRE subsystem further comprises of means for online processing of observed alarms in a transaction to derive segments of alarm sequences.

9. The system of claim 8, wherein said means for online processing of observed alarms to derive segments of alarm sequences further comprises of means to identify the missing alarms in a derived segment by comparing with the annotation associated with the transaction and resolving the ambiguity arising out of missing of alarms by analyzing alarm specific monitor variables along with specified rules.

10. The system of claim 2, wherein said TRE subsystem further comprises of means to infer the occurrence of a fault based on the analysis of annotations identified during alarm processing along with their pre- and post-conditions, and post-actions.

11. The system of claim 2, wherein said TRE subsystem further comprises of means to validate the occurrence of a fault inferred by other subsystems, based on the analysis of AMVs associated with the inferred fault.

12. The system of claim 1, wherein said FRE subsystem, further comprises a procedure to use the function space information by identifying the function space element associated with a generated alarm in a transaction.

13. The system of claim 12, wherein said FRE subsystem further comprises of a procedure to use the knowledge repository of plurality of information comprising of functions-rules information and monitor function information for the inference and validation of faults.

14. The system of claim 12, wherein said FRE subsystem further comprises of a procedure to collect plurality of information from the core electronic system through a software interface and provide the same to blackboard subsystem.

15. The system of claim 12, wherein said FRE subsystem further comprises of means to infer faults based on the analysis of results of a monitor function implemented in the core electronic system for the purposes of assessing the behavior of the corresponding critical function.

16. The system of claim 12, wherein said FRE subsystem further comprises of means to validate the occurrence of a fault inferred by other subsystems based on the analysis of learned rules that correlate the function-alarm associations with fault occurrences.

17. The system of claim 16, wherein said FRE subsystem further comprises of means to learn rules for correlating function-alarm associations with faults based on the positive examples on rectification of the identified faults.

18. The system of claim 1, wherein said SRE subsystem, comprises of a procedure to use the signal space information by identifying the signal space elements associated with an alarm for the inference and validation of faults.

19. The system of claim 18, wherein said SRE subsystem further comprises of a procedure to use the knowledge repository of plurality of information comprising of resource information, component information, hardware specific signatures, hardware specific monitor variable information and hardware specific rules for the inference and validation of faults.

20. The system of claim 18, wherein said SRE subsystem further comprises of a procedure to collect plurality of information from the core electronic system through a software interface and provide the same to blackboard subsystem.

21. The system of claim 18, wherein said SRE subsystem further comprises of means to infer faults based on the analysis of hardware monitor variables and environmental monitor variables along with the associated rules.

22. The system of claim 18, wherein said SRE subsystem further comprises of means to validate the occurrence of a fault inferred by other subsystems based on the aging analysis of the hardware components associated with the inferred fault.

23. The system of claim 1, wherein said MRE subsystem, comprises of a procedure to use domain specific monitor variables associated with faults, the associated unique signatures and the associated rules for the inference of faults.

24. The system of claim 23, wherein said MRE subsystem further comprises of a procedure to use the knowledge repository of plurality of information comprising of domain specific monitor variable data, domain specific signatures and domain specific rules for the inference of faults.

25. The system of claim 1, wherein said ERE subsystem, comprises of a procedure to use the execution space information by identifying the execution space element associated with an alarm for the inference and validation of faults.

26. The system of claim 25, wherein said ERE subsystem further comprises of a procedure to use the knowledge repository of plurality of information comprising of execution specific signatures, execution specific monitor variable information and execution specific rules for the inference and validation of faults.

27. The system of claim 25, wherein said ERE subsystem further comprises of means to infer faults based on the analysis of execution monitor variables along with plurality of associated rules.

28. The system of claim 25, wherein said ERE subsystem further comprises of means to validate the occurrence of a fault inferred by other subsystems based on the comparison of trends of execution specific monitor variables with the learned signatures for the corresponding execution specific monitor variables.

29. The system of claim 25, wherein said ERE subsystem further comprises of means to learn a set of signatures for each execution specific monitor variable based on the positive examples on rectification of the identified faults.

30. The system of claim 1, wherein said GRE subsystem, comprises of means to moderate the inferences and validations posted by various subsystems to derive a consolidated fault inference.

31. The system of claim 30, wherein said GRE subsystem further comprises of a procedure to use the knowledge repository of plurality of information comprising of fault information and inference-validation table to derive consolidated fault inferences.

32. The system of claim 30, wherein said GRE subsystem further comprises of means to learn a correction factor for the inferences made by the various subsystems based on positive and negative examples on rectification/rejection of the identified faults.

33. The system of claim 1, wherein said CIC subsystem, comprises of means to collect contextual information related to alarms in terms of transaction, function, and usecase information and to collect various monitor variables in the system.

34. An apparatus, for efficiently identifying the faults occurring in a core electronic system based on the analysis of observed alarm information and the state of hardware and software subsystems comprising of means for reducing the ambiguity and complexity arising due to the enormity of the alarms generated by the system, comprising of:
(a) a hardware subsystem for performing the identification of faults in the core electronic system;
(b) a hardware subsystem for collecting the specified monitor variables from the core electronic subsystem;
(c) a software subsystem for collecting the plurality of information from core electronic subsystem.
(d) a software subsystem for performing the identification of faults in the core electronic system;

35. The apparatus of claim 34, wherein said hardware subsystem for performing identification of faults comprises of:
(a) A processor of appropriate capacity;
(b) Memory devices of appropriate capacity; and
(c) Interface subsystem for interacting with the core electronic system and with the knowledge repositories.

36. The apparatus of claim 34, wherein said hardware subsystem for collecting the specified monitor variables from the core electronic subsystem comprises of sensor appropriately located in the core electronic system.

37. The apparatus of claim 36, further comprises of hardware devices to facilitate the collection of internally defined monitor variables from meta-components in the core electronic system wherein a meta-component has been suitably design to provide the internally defined monitor variables to the hardware devices.

38. The apparatus of claim 34, wherein said software subsystem for collecting the plurality of information from the core electronic subsystem comprises of software agents implemented as part of software components of the core electronic system.

39. The apparatus of claim 34, wherein said software subsystem for performing the identification of faults in the core electronic system comprises of software to process the information, collected from the software agents, using the knowledge repositories.

40. A method for efficiently identifying the faults occurring in a core electronic system based on the analysis of observed alarm information and the state of hardware and software subsystems comprising of means for reducing the ambiguity and complexity arising due to the enormity of the alarms generated by the system, comprising the step of diagnosis-oriented designing of the electronic system for reducing the ambiguity and complexity arising due to the enormity of the alarms generated by the system.

41. The method of claim 40 further comprises of one of the steps as the identification of components and meta-components information comprising of aging parameters and operating conditions; resource hierarchy; and hardware specific monitor variables and environmental variables along with associated rules and signatures wherein the said identification is based on the analysis of system specification and component data by a group system designers.

42. The method of claim 41 further comprises of a step to use the simulation results, and test and operation data of a prototype by a group of system analysts to derive appropriate rules and signatures.

43. The method of claim 40 further comprises of one of the steps as the identification of the faults and fault-component inter-relations of the core electronic system based on the failure mode analysis by a group of experts.

44. The method of claim 40 further comprises of one of the steps as the identification of usecases, transactions of a usecase, alarms and annotations associated with each transaction based on the software specification, software design and function graphs by a group of software design specialists.

45. The method of claim 44 further comprises of one of the steps as the identification of pre- and post-conditions, and post-actions associated with annotations; and identification of alarm specific monitor variable along with associated signatures and rules based on transaction and resource hierarchies.

46. The method of claim 40 further comprises of one of the steps as the identification of domain specific monitor variables along with associated signatures and rules and identification and designing of monitor functions for critical functions based on system specification and system design by a group of system designers.

47. The method of claim 40 further comprises of one of the steps as the identification of execution specific monitor variables along with associated signatures and rules based on software execution environment by a group of software specialists.
